(19) United States
(12) Patent Application Publication
(10) Pub. No.: US 2023/0295471 A1
(43) Pub. Date: Sep. 21, 2023

(54) FLOOR MARKING TAPE

(71) Applicant: Brady Worldwide, Inc., Milwaukee, WI (US)

(72) Inventors: Alexander Huhn, Mequon, WI (US); Andrew Hoffman, Port Washington, WI (US)

(21) Appl. No.: 18/124,282

(22) Filed: Mar. 21, 2023

Related U.S. Application Data
(60) Provisional application No. 63/321,903, filed on Mar. 21, 2022.

(51) Int. Cl. C09J 7/38; C09J 7/22

(52) U.S. Cl. CPC C09J 7/38; C09J 7/22; C09J 2203/37; C09J 2301/1242; C09J 2301/302; C09J 2301/312

(57) ABSTRACT

The present disclosure provides a floor marking tape. The floor marking tape has a total thickness of less than 40 mil (1.016 mm). The floor marking tape includes (A) a top layer including a polymer having a flexural strength of greater than 2,100 psi (14.48 MPa) and (B) an adhesive layer including a pressure sensitive adhesive (PSA) in contact with the top layer.

### BACKGROUND

The present disclosure is directed to floor marking tapes.

Durable floor marking tapes that will withstand heavy traffic under industrial conditions are desired for use in factories and commercial settings. Heavy traffic includes areas subject to forklift wheels going straight, turning or pivoting, cleaning scrubbers, skids being dragged, hand carts, pallet jacks, metal shavings or debris embedded into wheels, and frequent foot traffic. The tape should be easy to install in straight lines, temporarily repositionable, yet also build sufficiently high adhesion. It should be removable without leaving adhesive residue that cannot be easily cleaned. Typically, it is available in multiple colors and capable of being printed with various graphics such as diagonal stripes. Occasionally it is used in discontinuous shapes (e.g., corner L's, T's, dots, dashes, etc.) and sometimes floor signs are made from it.

A longstanding problem in floor marking tapes is the provision of a thin tape with sufficient durability. Thick tapes can be problematic in heavy traffic areas because they create barriers on the floor that wheels must maneuver over (potentially causing instability in the object being moved over the floor tape), and can cause tripping. Attempts have been made to minimize the impact that thick floor tapes have on wheels and foot traffic by providing a tapered edge that decreases in thickness towards each opposing edge of the tape. However, these tapered-edge floor marking tapes generally do not include adhesive from edge-to-edge, which decreases the durability of the floor marking tape.

The art recognizes the need for a thin and durable floor marking tape.

### SUMMARY

The present disclosure provides a floor marking tape. The floor marking tape has a total thickness of less than 40 mil (1.016 mm). The floor marking tape includes (A) atop layer including a polymer having a flexural strength of greater than 2,100 psi (14.48 MPa) and (B) an adhesive layer including a pressure sensitive adhesive (PSA) in contact with the top layer.

In an embodiment, the floor marking tape having a total thickness of less than 40 mil (1.016 mm) includes (A) atop layer including a polymer having a flexural strength of greater than 12,100 psi (14.48 MPa); (B) an adhesive layer including a pressure sensitive adhesive (PSA) in contact with the top layer; and (C) an optional release liner in direct contact with the adhesive layer.

In an embodiment, the floor marking tape having a total thickness of less than 40 mil (1.016 mm) includes (A) a top layer including a first polymer having a flexural strength of greater than 2,100 psi (14.48 MPa); (B) a first adhesive layer including a first pressure sensitive adhesive (PSA) in contact with the top layer; (C) an intermediate layer including a second polymer in contact with the first adhesive layer; and (D) a second adhesive layer including a second pressure sensitive adhesive (PSA) in contact with the intermediate layer.

In an embodiment, the floor marking tape having a total thickness of less than 40 mil (1.016 mm) includes (A) a top layer including a first polymer having a flexural strength of greater than 2,100 psi (14.48 MPa); (B) a first adhesive layer including a first pressure sensitive adhesive (PSA) in contact with the top layer; (C) an intermediate layer including a second polymer in contact with the first adhesive layer; (D) a second adhesive layer including a second pressure sensitive adhesive (PSA) in contact with the intermediate layer; and (E) an optional release liner in direct contact with the second adhesive layer.

In an embodiment, the floor marking tape having a total thickness of less than 40 mil (1.016 mm) includes (A) a top layer including a first polymer having a flexural strength of greater than 2,100 psi (14.48 MPa); (B) a first adhesive layer including a first pressure sensitive adhesive (PSA) in contact with the top layer; (C) a pigment layer containing a pigment in contact with the first adhesive layer; (D) an intermediate layer including a second polymer in contact with the pigment layer; and (E) a second adhesive layer including a second pressure sensitive adhesive (PSA) in contact with the intermediate layer. In some embodiments, the floor marking tape further includes (F) an optional release liner in direct contact with the second adhesive layer.

In an embodiment, the floor marking tape having a total thickness of less than 40 mil (1.016 mm) includes (A) a top layer including a first polymer having a flexural strength of greater than 2,100 psi (14.48 MPa); (B) a pigment layer containing a pigment in contact with the top layer; (C) a first adhesive layer including a first pressure sensitive adhesive (PSA) in contact with the pigment layer; (D) an intermediate layer including a second polymer in contact with the first adhesive layer; and (E) a second adhesive layer including a second pressure sensitive adhesive (PSA) in contact with the intermediate layer. In some embodiments, the floor marking tape further includes (F) an optional release liner in direct contact with the second adhesive layer.

### BRIEF DESCRIPTION OF THE DRAWINGS

FIG. 1 is a schematic of a floor marking tape in accordance with an embodiment of the present disclosure.

FIG. 2 is a schematic of a floor marking tape in accordance with another embodiment of the present disclosure.

FIG. 3 is a schematic of a floor marking tape in accordance with another embodiment of the present disclosure.

FIG. 4 is a perspective view of a floor marking tape in accordance with an embodiment of the present disclosure.

FIG. 5 is a schematic of the layout of the examples in Round 1 of the present disclosure.

FIG. 6 is a schematic of the layout of the examples in Round 2 of the present disclosure.

FIG. 7 is a schematic of the layout of the examples in Round 3 of the present disclosure.

FIG. 8 is a schematic of the layout of the examples in Round 4 of the present disclosure.

FIG. 9 is a table containing photographs taken of samples of Ex. A, Ex. D, and Ex. K during Round 1 of the examples of the present disclosure, after seven weeks.

FIG. 10 is a table containing photographs taken of samples of Ex. U during Round 1 of the examples of the present disclosure, after seven weeks.

FIG. 11 is a table containing photographs taken of samples of Ex. B, Ex. E, and Ex. L during Round 1 of the examples of the present disclosure, after seven weeks.

FIG. 12 is a table containing photographs taken of samples of Ex. P during Round 2 of the examples of the present disclosure, after seven weeks.

FIG. 13 is a table containing photographs taken of samples of Ex. C, Ex. F, and Ex. M during Rounds 1 and 2 of the examples of the present disclosure, after seven weeks.

FIG. 14 is a table containing photographs taken of samples of Ex. J, Ex. O, Ex. R, Ex. RM, Ex. T, Ex. V, and Ex. W during Rounds 1-3 of the examples of the present disclosure, after seven weeks.

FIG. 15 is a table containing photographs taken of samples of Ex. Z, Ex. AA, and Ex. AB during Round 4 of the examples of the present disclosure, after seven weeks.

FIG. 16 is a table containing photographs taken of samples of Ex. AC, Ex. AD, and Ex. AE during Round 4 of the examples of the present disclosure, after seven weeks.

FIG. 17 is a table containing photographs taken of samples of Ex. X and Ex. Y during Round 4 of the examples of the present disclosure, after seven weeks.

FIG. 18 is a table containing photographs taken of samples of CS 1, CS 2, and CS 3 during Rounds 1-4 of the examples of the present disclosure, after seven weeks.

FIG. 19 is a table containing photographs taken of samples of CS 2, Ex. R, and Ex. M during Round 2 of the examples of the present disclosure, after twenty-three weeks.

### DEFINITIONS AND TEST METHODS

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

Any reference to the Periodic Table of Elements is that as published by CRC Press, Inc., 1990-1991. Reference to a group of elements in this table is by the new notation for numbering groups.

Density is measured in accordance with ASTM D792, Method B. The result is recorded in grams (g) per cubic centimeter (g/cc or g/cm3).

“Graphic image” and like terms mean text or pictorial representations formed of ink or other dye or pigments substances. Graphic images include, but are not limited to, words, numbers, bar codes, pictures, designs (geometric or otherwise), and solid colors (typically applied by flood coating).

The terms “comprising,” “including,” “having,” and their derivatives, are not intended to exclude the presence of any additional component, step, or procedure, whether or not the same is specifically disclosed. In order to avoid any doubt, all articles claimed through use of the term “comprising” may include any additional component, feature, or element, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa. As used herein, “a,” “an,” “the,” “at least one,” and “one or more” are used interchangeably.

The term “contact” includes direct contact and indirect contact.

“Direct contact” refers to a layer configuration whereby a first layer is located immediately adjacent to a second layer and no intervening layers or no intervening structures are present between the first layer and the second layer.

“Ethylene-based polymer” as used herein, refers to a polymer that comprises, in polymerized form, a majority weight percent (wt %) of ethylene monomer (based on the total weight of the polymer), and optionally may comprise one or more comonomers. Nonlimiting examples of ethylene-based polymers include medium density polyethylene (MDPE), high density polyethylene (HDPE), and functionalized polyethylene, e.g., ethylene vinyl acetate (EVA), ethylene ethyl acrylate (EEA), and the like.

“High density polyethylene” (or “HDPE”) is an ethylene homopolymer or an ethylene/α-olefin copolymer with at least one C4-C10 α olefin comonomer, or C4 α-olefin comonomer and a density from greater than 0.94 g/cc, or 0.945 g/cc, or 0.95 g/cc, or 0.955 g/cc, to 0.96 g/cc to 0.97 g/cc, or 0.98 g/cc. The HDPE can be a monomodal copolymer or a multimodal copolymer. A “monomodal ethylene copolymer” is an ethylene/C4-C10 α-olefin copolymer that has one distinct peak in a gel permeation chromatography (GPC) showing the molecular weight distribution. A “multimodal ethylene copolymer” is an ethylene/C4-C10 α-olefin copolymer that has at least two distinct peaks in a GPC showing the molecular weight distribution. Multimodal includes copolymer having two peaks (bimodal) as well as copolymer having more than two peaks. Nonlimiting examples of HDPE are RTP™ Abrasion Resistant HDPE Resins (available from RTP Company), DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

“Indirect contact” refers to a layer configuration whereby a first layer is located adjacent to a second layer and at least one intervening layer or intervening structure is present between the first layer and the second layer.

A “layer” is a single thickness or coating of a compound, polymer, or composition spread out or covering a surface.

A “non-surface layer” is a layer positioned between at least two layers. Neither of the two opposing planar surfaces of a non-surface layer is exposed to the environment.

The term “parallel,” as used herein, refers to structures or axes extending in the same direction along the length of the structures or direction of the axes, wherein a spatial distance between the structures or axes does not change along the length of the structures or direction of the axes.

The term “perpendicular,” as used herein, refers to structures or axes extending in directions that intersect at a 90°, or substantially a 90° angle along the length of the structures or direction of the axes.

“Pigment” refers to a visible light absorbing material or compound that is present in a non-molecularly dispersed (particulate) form.

“Planar surface”, “facial surface”, “top surface”, “bottom surface” and the like are used in distinction to “edge surface.” If rectangular in shape or configuration, a tape will have two opposing planar surfaces joined by four edge surfaces (two opposing pairs of edge surfaces, each pair intersecting the other pair at right angles). If circular in configuration, then the tape will have two opposing planar surfaces joined by one continuous edge surface. While the tapes of this invention are limited to a defined range of thickness, the planar dimensions of the tape can be of any length and/or width and shape and as such, so can the planar and edge surfaces, e.g., polygonal or circular, flat or wavy, etc. Typically, the tape is of conventional planar dimensions, e.g., from 0.25 to 15 inches, or from 1 to 10 inches, or from 2 to 8 inches, or from 2 to 4 inches, in width with a length of 1, 3, 5, 10, 20, 30, 40, 50, 100, 150, 200, or more feet wound and stored in roll form on a cylindrical tube. Top surface and bottom surface are relative terms and in the context of this invention, the bottom surface of a layer is the surface closest to the substrate when the tape is applied to the substrate, e.g., a factory floor, and the top surface of a layer is the surface distal to the substrate when the tape is applied to the substrate.

A “polyamide” is a polymer with repeating units linked by amide bonds. Nonlimiting examples of polyamides include aliphatic polyamides (e.g., nylon), polythalamides, and aromatic polyamides (e.g., poly-paraphenylene terephthalamide (i.e., Kevlar™)). Nonlimiting examples of nylon are nylon 6 and nylon 6/6. A nonlimiting example of nylon 6/6 is RTP™ 200 ABR (available from RTP Company). A nonlimiting example of nylon 6 is RTP™ 200 A ABR (available from RTP Company).

A “polyester” is a polymer with repeating units that contain an ester functional group. Nonlimiting examples of polyesters include polyethylene terephthalate (PET), poly-cyclohexylenedimethylene terephthalate glycol-modified (PCTG), and glycol-modified polyethylene terephthalate (PETG). Nonlimiting examples of PETG include Skygreen K2012, Ecozen T110 Plus, and Ecozen T110 Pro, each available from SK Chemicals. A nonlimiting example of PCTG is Skygreen JN200, available from SK Chemicals.

A “polygon” is a closed-plane figure bounded by at least three sides. The polygon can be a regular polygon, or an irregular polygon having three, four, five, six, seven, eight, nine, ten, or more sides. Nonlimiting examples of suitable polygonal shapes include triangle, square, rectangle, diamond, trapezoid, parallelogram, hexagon, and octagon.

A “polymer” is a macromolecular compound prepared by polymerizing monomers of the same or different type. “Polymer” includes homopolymers, copolymers, terpolymers, interpolymers, and so on. An “interpolymer” is a polymer prepared by the polymerization of at least two types of monomers or comonomers. It includes, but is not limited to, copolymers (which usually refers to polymers prepared from two different types of monomers or comonomers, terpolymers (which usually refers to polymers prepared from three different types of monomers or comonomers), tetrapolymers (which usually refers to polymers prepared from four different types of monomers or comonomers), and the like.

“Polyolefin” or “olefin-based polymer” is a polymer containing, in polymerized form, a majority weight percent of an olefin, for example ethylene or propylene, based on the total weight of the polymer. Non-limiting examples of olefin-based polymers include ethylene-based polymers and propylene-based polymers.

A “pressure sensitive adhesive” or “PSA” is a type of adhesive composition that forms a bond with a surface, such as a substrate surface or a layer surface, upon the application of pressure.

“Propylene-based polymer” as used herein, refers to a polymer that comprises, in polymerized form, a majority weight percent (wt %) of propylene monomer (based on the total weight of the polymer), and optionally may comprise one or more comonomers. A nonlimiting example of a propylene-based polymer is propylene homopolymer (polypropylene).

A “tape” is an elongated strip of material, typically stored on a roll, having a top layer and an adhesive layer.

“Translucent” as used in the context of this invention includes transparent and includes a material or layer that allows light to pass through. Translucent excludes opaque.

A “vinyl polymer” is a polymer derived from a substituted vinyl monomer. Nonlimiting examples of vinyl polymer include polyvinyl chloride (PVC), polyvinyl acetate (PVAc), and polyvinylidene fluoride (PVDF).

Flexural strength is measured in accordance with ASTM D790.

Rockwell hardness is measured in accordance with ASTM D785 (R-scale).

Tensile strength is measured in accordance with ASTM D638. As used herein, tensile strength refers to tensile strength at break.

Shore D hardness is measured in accordance with ASTM D2240.

Storage modulus (G′) is measured using Dynamic Mechanical Analysis (DMA) using the Tension Frequency Sweep method at 25° C., reporting data at 1 Hz frequency only. A maximum of 30 N force is used to achieve a displacement of 10.00 micron.

### DETAILED DESCRIPTION

The present disclosure provides floor marking tape having a total thickness of less than 40 mil (1.016 mm). The floor marking tape includes (A) a top layer including a polymer having a flexural strength of greater than 2,100 psi (14.48 MPa) and (B) an adhesive layer including a pressure sensitive adhesive (PSA) in contact with the top layer.

In an embodiment, the floor marking tape having a total thickness of less than 40 mil (1.016 mm) includes (A) a top layer including a polymer having a flexural strength of greater than 2,100 psi (14.48 MPa); (B) an adhesive layer including a pressure sensitive adhesive (PSA) in contact with the top layer; and (C) an optional release liner in contact with the adhesive layer.

In an embodiment, the floor marking tape having a total thickness of less than 40 mil (1.016 mm) includes (A) a top layer including a first polymer having a flexural strength of greater than 2,100 psi (14.48 MPa); (B) a first adhesive layer including a first pressure sensitive adhesive (PSA) in contact with the top layer; (C) an intermediate layer including a second polymer in contact with the first adhesive layer; and (D) a second adhesive layer including a second pressure sensitive adhesive (PSA) in contact with the intermediate layer. In some embodiments, the floor marking tape further includes (E) an optional release liner in contact with the second adhesive layer.

In an embodiment, the floor marking tape having a total thickness of less than 40 mil (1.016 mm) includes (A) a top layer including a first polymer having a flexural strength of greater than 2,100 psi (14.48 MPa); (B) a first adhesive layer including a first pressure sensitive adhesive (PSA) in contact with the top layer; (C) a pigment layer including a pigment in contact with the first adhesive layer; (D) an intermediate layer including a second polymer in contact with the pigment layer; and (E) a second adhesive layer including a second pressure sensitive adhesive (PSA) in contact with the intermediate layer. In some embodiments, the floor marking tape further includes (F) an optional release liner in contact with the second adhesive layer.

In an embodiment, the floor marking tape having a total thickness of less than 40 mil (1.016 mm) includes (A) a top layer including a first polymer having a flexural strength of greater than 2,100 psi (14.48 MPa); (B) a pigment layer including a pigment in contact with the top layer; (C) a first adhesive layer including a first pressure sensitive adhesive (PSA) in contact with the pigment layer; (D) an intermediate layer including a second polymer in contact with the first adhesive layer; and (E) a second adhesive layer including a second pressure sensitive adhesive (PSA) in contact with the intermediate layer. In some embodiments, the floor marking tape further includes (F) an optional release liner in contact with the second adhesive layer.

A. Top Layer

The floor marking tape includes a top layer. The top layer includes a polymer having a flexural strength of greater than 2,100 psi (14.48 MPa).

The top layer is the layer distal to a substrate when the floor marking tape is applied to the substrate (e.g., a factory floor, store floor, etc.).

The top layer includes a polymer. Nonlimiting examples of suitable polymers include polyolefins, polyamides, polyesters, vinyl polymers, polycarbonates, and combinations thereof.

In an embodiment, the polymer is a polyolefin. Nonlimiting examples of suitable polyolefins include ethylene-based polymer, polybutene, propylene-based polymer, and combinations thereof.

In an embodiment, the polyolefin is a propylene-based polymer. A nonlimiting example of a suitable propylene-based polymer is polypropylene.

In an embodiment, the polyolefin is an ethylene-based polymer. A nonlimiting example of a suitable ethylene-based polymer is HDPE. In an embodiment, the ethylene-based polymer has a density greater than 0.92 g/cc, or greater than 0.93 g/cc, or greater than 0.94 g/cc. In another embodiment, the ethylene-based polymer has a density of from greater than 0.92 g/cc to 0.99 g/cc, or from 0.93 g/cc to 0.98 g/cc, or from 0.94 g/cc to 0.98 g/cc, or from 0.94 g/cc to 0.96 g/cc. In a further embodiment, the ethylene-based polymer has a density of from 0.93 g/cc, or 0.94 g/cc, or 0.95 g/cc to 0.96 g/cc, or 0.97 g/cc, or 0.98 g/cc, or 0.99 g/cc.

In an embodiment, the polyolefin is HDPE. In a further embodiment, the HDPE has a density of from greater than 0.92 g/cc to 0.99 g/cc, or from 0.93 g/cc to 0.98 g/cc, or from 0.94 g/cc to 0.98 g/cc, or from 0.94 g/cc to 0.96 g/cc. In an embodiment, the HDPE has a density of from 0.93 g/cc, or 0.94 g/cc, or 0.95 g/cc to 0.96 g/cc, or 0.97 g/cc, or 0.98 g/cc, or 0.99 g/cc.

In an embodiment, the polyolefin is polybutene.

In an embodiment, the polymer is a polyolefin selected from polypropylene, HDPE, polybutene, and combinations thereof.

In an embodiment, the polymer is a polyamide. Nonlimiting examples of suitable polyamides include poly[imino(1,6-dioxohexamethylene) iminohexamethylene] (also known as nylon 6/6), polycaprolactam (also known as nylon 6), and combinations thereof. In an embodiment, the polyamide is nylon 6.

In an embodiment, the polymer is a polyester. Nonlimiting examples of suitable polyesters include poly-cyclohexylenedimethylene terephthalate glycol-modified (PCTG), glycol-modified polyethylene terephthalate (PETG), and combinations thereof. A nonlimiting example of a suitable PCTG is Skygreen JN200, available from SK Chemicals. Nonlimiting examples of suitable PETG include Skygreen K2012, Ecozen T110 Plus, and Ecozen T110 Pro, each available from SK Chemicals.

In an embodiment, the polymer is a vinyl polymer. Nonlimiting examples of suitable vinyl polymer include PVC, PVDF, and combinations thereof. In an embodiment, the vinyl polymer is PVC. In another embodiment, the vinyl polymer is PVDF.

In an embodiment, the polymer is selected from HDPE, polybutene, polypropylene, nylon 6, nylon 6/6, PVC, PVDF, PCTG, PETG, and combinations thereof.

In an embodiment, the polymer is selected from HDPE, polybutene, polypropylene, nylon 6, nylon 6/6, PVDF, PCTG, PETG, and combinations thereof.

In another embodiment, the polymer is selected from HDPE, polybutene, polypropylene, nylon 6, nylon 6/6, PVC, PVDF, and combinations thereof.

In one embodiment, the polymer is selected from HDPE, polybutene, polypropylene, nylon 6, nylon 6/6, PVDF, and combinations thereof.

In an embodiment, the polymer is selected from PCTG, PETG, and combinations thereof.

In some embodiments, the top layer includes a polymeric composition containing the polymer and one or more optional additives. Nonlimiting examples of suitable optional additives include pigments, surfactants, fillers, plasticizers, heat stabilizers, UV absorbers, and combinations thereof. In an embodiment, the top layer includes a polymeric composition containing the polymer and a pigment. A nonlimiting example of a suitable pigment is titanium dioxide.

In an embodiment, the top layer, and further the polymeric composition, includes at least 50 wt %, or at least 55 wt %, or at least 60 wt %, or at least 75 wt % of the polymer, based on the total weight of the top layer or polymeric composition. In a further embodiment, the top layer, and further the polymeric composition, includes from greater than 50 wt % to less than 100 wt %, or from 55 wt % to 99 wt %, or from 60 wt % to 99 wt %, or from 65 wt % to 99 wt %, or from 70 wt % to 99 wt %, or from 75 wt % to 99 wt %, or from 80 wt % to 99 wt %, or from 90 wt % to 99 wt % of the polymer; and a reciprocal amount of optional additives (e.g., pigment), or from 0 wt % to less than 50 wt %, or from 1 wt % to 45 wt %, or from 1 wt % to 40 wt %, or from 1 wt % to 35 wt %, or from 1 wt % to 30 wt %, or from 1 wt % to 25 wt %, or from 1 wt % to 20 wt %, or from 1 wt % to 10 wt % optional additive, based on the total weight of the top layer or polymeric composition.

In an embodiment, the top layer is translucent. In a further embodiment, the top layer is translucent and is void of, or excludes, pigment.

The top layer includes a polymer having a flexural strength of greater than 2,100 psi (14.48 MPa). In another embodiment, the top layer includes a polymeric composition having a flexural strength of greater than 2,100 psi (14.48 MPa).

In an embodiment, the polymer, or further the polymeric composition, has a flexural strength of greater than 2,100 psi, or greater than 2,200 psi, or greater than 2,300 psi, or greater than 2,400 psi, or greater than 2,500 psi, or greater than 3,000 psi. In another embodiment, the polymer, or further the polymeric composition, has a flexural strength of from greater than 2,100 psi to 15,000 psi, or from 2,200 psi to 15,000 psi, or from 2,200 psi to 12,000 psi, or from 2,100 psi to 10,000 psi, or from 2,200 psi to 15,000 psi, or from 2,200 psi to 10,000 psi, or from 2,400 psi to 15,000 psi, or from 2,400 psi to 10,000 psi, or from 2,500 psi to 10,000 psi. In another embodiment, the polymer, or further the polymeric composition, has a flexural strength of from 2100 psi, or 2200 psi, or 2300 psi, or 2400 psi, or 2500 psi, or 3000 psi, or 3500 psi, or 4000 psi to 5000 psi, or 6000 psi, or 7000 psi, or 8000 psi, or 9000 psi, or 10000 psi, or 12000 psi, or 15000 psi.

In an embodiment the polymer, or further the polymeric composition, has a tensile strength of greater than 3,000 psi, or greater than 3,500 psi, or greater than 4,000 psi, or greater than 4,500 psi. In another embodiment, the polymer, or further the polymeric composition, has a tensile strength of from 3000 psi, or 3500 psi, or 4000 psi, or 4500 psi to 5000 psi, or 5500 psi, or 6000 psi, or 6500 psi, or 7000 psi, or 8000 psi, or 9000 psi. In an embodiment, the polymer, or further the polymeric composition, has a tensile strength of from 3,000 psi to 9,000 psi, or from 3,000 psi to 8,000 psi, or from 3,000 psi to 7,000 psi, or from 3,500 psi to 7,000 psi, or from 3,500 psi to 6,500 psi, or from 4,000 psi to 8,000 psi, or from 4,000 psi to 6,500 psi.

In an embodiment, the polymer, or further the polymeric composition, has a Shore D hardness of at least 50, or at least 55 or at least 60, or at least 65, or at least 68, or at least 70. In another embodiment, the polymer, or further the polymeric composition, has a Shore D hardness of from 50 to 90, or from 55 to 90, or from 60 to 90, or from 65 to 90, or from 68 to 90, or from 70 to 90, or from 65 to 80, or from 70 to 80. In a further embodiment, the polymer, or further the polymeric composition, has a Shore D hardness of from 50, or 55, or 60, or 65, or 68 to 70, or 75, or 80, or 85, or 90.

In an embodiment, the polymer, or further the polymeric composition, has a Rockwell hardness (R-scale) of at least 50, or at least 50, or at least 65, or at least 70, or at least 80, or at least 90, or at least 100, or at least 105. In another embodiment, the polymer, or further the polymeric composition, has a Rockwell hardness (R-scale) of from 50 to 130, or from 65 to 130, or from 70 to 130, or from 80 to 130, or from 100 to 130, or from 105 to 130. In a further embodiment, the polymer, or further the polymeric composition, has a Rockwell hardness (R-scale) of from 50, or 55, or 60, or 65, or 70, or 75, or 80, or 85, or 90, or 95, or 100, or 105 to 115, or 120, or 125, or 130.

In an embodiment, the polymer, or further the polymeric composition, has a storage modulus (G′) of at least 750 MPa, or at least 800 MPa, or at least 900 MPa, or at least 1000 MPa, or at least 1200 MPa. In another embodiment, the polymer, or further the polymeric composition, has a storage modulus (G′) of from 750 MPa, or 800 MPa, or 900 MPa, or 1000 MPa, or 1200 MPa, or 1250 MPa to 1900 MPa, or 1950 MPa, or 2000 MPa, or 2200 MPa, or 2500 MPa. In a further embodiment, the polymer, or further the polymeric composition, has a storage modulus (G′) of from 750 MPa to 2,500 MPa, or from 1,000 MPa to 2,000 MPa, or from 1,200 MPa to 2,000 MPa.

In an embodiment, the polymer, or further the polymeric composition has a flexural strength of from greater than 2,100 psi to 15,000 psi, or from 2,200 psi to 15,000 psi, or from 2,200 psi to 12,000 psi, or from 2,100 psi to 10,000 psi, or from 2,200 psi to 15,000 psi, or from 2,200 psi to 10,000 psi, or from 2,400 psi to 15,000 psi, or from 2,400 psi to 10,000 psi, or from 2,500 psi to 10,000 psi; and the polymer, or further the polymeric composition, has one, some, or all of the following properties:
(a) a tensile strength of from 3,000 psi to 9,000 psi, or from 3,000 psi to 8,000 psi, or from 3,000 psi to 7,000 psi, or from 3,500 psi to 7,000 psi, or from 3,500 psi to 6,500 psi, or from 4,000 psi to 8,000 psi, or from 4,000 psi to 6,500 psi; and/or
(b) a Shore D hardness of from 50 to 90, or from 55 to 90, or from 60 to 90, or from 65 to 90, or from 68 to 90, or from 70 to 90, or from 65 to 80, or from 70 to 80; and/or
(c) a Rockwell hardness (R-scale) of from 50 to 130, or from 65 to 130, or from 70 to 130, or from 80 to 130, or from 100 to 130, or from 105 to 130; and/or
(d) a storage modulus (G′) of from 750 MPa to 2,500 MPa, or from 1,000 MPa to 2,000 MPa, or from 1,200 MPa to 2,000 MPa.

In an embodiment, the top layer has a thickness of from 12 mil, or 13 mil, or 14 mil, or 15 mil to 16 mil, or 17 mil, or 18 mil, or 20 mil, or 25 mil, or 30 mil, or less than 40 mil. In another embodiment, the top layer has a thickness of from 12 mil to less than 40 mil, or from 12 mil to 30 mil, or from 12 mil to 25 mil, or from 15 mil to 25 mil, or from 15 mil to 20 mil, or from 15 mil to 18 mil. In a further embodiment, the top layer has a thickness of from 12 mil to less than 20 mil, or from 15 mil to less than 20 mil.

In an embodiment, the top layer has a substantially uniform thickness from each edge surface to the opposing edge surface. In other words, the top layer excludes, or is void of, a tapered edge in which the thickness of the top layer decreases at two opposing edge surfaces.

In an embodiment, the top layer is void of, or substantially void of, PVC.

The top layer has a top facial surface and an opposing bottom facial surface. In a top layer having substantially uniform thickness from each edge surface to the opposing edge surface, the top facial surface and the opposing bottom facial surface extend parallel to each other.

In some embodiments, the top facial surface of the top layer contains a graphic image.

In some embodiments, the top layer is chemically treated or print-treated to promote adhesion to the top and/or bottom facial surface. In a further embodiment, the bottom facial surface of the top layer is corona treated.

The polymer and the polymeric composition may comprise two or more embodiments disclosed herein.

The top layer may comprise two or more embodiments disclosed herein.

B. Adhesive Layer

The floor marking tape includes an adhesive layer including a pressure sensitive adhesive (PSA) in contact with the top layer.

The adhesive layer has a top facial surface and an opposing bottom facial surface.

The adhesive layer may directly or indirectly contact the top layer.

In an embodiment, the top layer directly contacts the adhesive layer. In other words, the bottom facial surface of the top layer directly contacts the top facial surface of the adhesive layer. In another embodiment, the top layer indirectly contacts the adhesive layer.

In an embodiment, the adhesive layer is configured to directly contact a substrate when the floor marking tape is placed on the substrate. In other words, the bottom facial surface of the adhesive layer is configured to directly contact a substrate when the floor marking tape is placed on the substrate.

In an embodiment, the adhesive layer directly contacts the optional release liner, which is described in detail below. In other words, the bottom facial surface of the adhesive layer directly contacts a top facial surface of the release liner.

Nonlimiting examples of suitable pressure sensitive adhesives include acrylic-based PSAs, acrylic-hybrid PSAs, rubber-based PSAs, silicone-based PSAs, and combinations thereof. The PSA may be thermoplastic, solvent-based, or water-based.

In an embodiment, the PSA is an acrylic-based PSA. Acrylic-based PSAs are formed from an acrylic-based polymer. A nonlimiting example of a suitable acrylic-based PSA is LOCTITE™ DURO-TAK 230A, available from Henkel.

In an embodiment, the PSA is an acrylic-hybrid PSA. Nonlimiting examples of suitable acrylic hybrids include acrylic-rubber hybrid and acrylic-silicone hybrid PSAs. In an embodiment, the acrylic-hybrid PSA is an acrylic-rubber PSA. A nonlimiting example of a suitable acrylic-rubber PSA is LOCTITE™ DURO-TAK AH 115, available from Henkel.

In an embodiment, the PSA is a rubber-based PSA. Nonlimiting examples of suitable rubber-based PSAs include compositions containing (i) one or more polymers such as styrene-butadiene (SBR), styrenic block copolymer (such as polystyrene-polyisoprene-polystyrene (SIS) or polystyrene-polybutadiene-polystyrene (SBS)), and butyl rubber; and (ii) an optional tackifying resin such as polyisobutylene. Nonlimiting examples of suitable rubber-based PSAs include MORSTIK™ 123 and 190, available from The Dow Chemical Company; and Thermogrip™ 9492KN, available from Bostik. In an embodiment, the PSA is a rubber-based PSA containing butyl rubber, such as Thermogrip™ 9492KN.

In an embodiment, the PSA is selected from an acrylic-based PSA, an acrylic-hybrid PSA, a rubber-based PSA, and combinations thereof.

In an embodiment, the PSA includes one or more optional additives. A nonlimiting example of a suitable additive is a pigment, such as titanium dioxide.

In an embodiment, the adhesive layer has a thickness of from 1 mil, or 2 mil to 3 mil, or 4 mil, or 5 mil, or 6 mil, or 10 mil, or 12 mil, or 14 mil, or 15 mil, or 20 mil, or 25 mil, or 30 mil, or less than 40 mil. In another embodiment, the adhesive layer has a thickness of from 1 mil to 5 mil, or from 1 mil to 4 mil, or from 1 to 3 mil, or from 1 to 2 mil, or from 2 mil to 5 mil, or from 2 mil to 4 mil, or from 2 mil to 3 mil, or from 5 mil to 15 mil, or from 6 mil to 14 mil, or from 6 mil to 10 mil, or from 10 mil to 15 mil, or from 10 mil to 14 mil.

In an embodiment, the adhesive layer has a substantially uniform thickness from each edge surface to the opposing edge surface. In an adhesive layer having substantially uniform thickness from each edge surface to the opposing edge surface, the top facial surface and the opposing bottom facial surface extend parallel to each other.

In an embodiment, the PSA has a density of from 0.840 g/cc, or 0.845 g/cc, or 0.850 g/cc to 0.865 g/cc, or 0.870 g/cc, or 0.90 g/cc, or 0.95 g/cc, or 1.00 g/cc, or 1.40 g/cc, or 1.50 g/cc, or 1.60 g/cc, or 1.80 g/cc. In a further embodiment, the PSA has a density of from 0.840 g/cc to 1.80 g/cc, or from 0.850 g/cc to 1.50 g/cc, or from 0.850 g/cc to 0.90 g/cc, or from 0.850 g/cc to 0.870 g/cc, or from 1.00 g/cc to 1.50 g/cc, or from 1.30 g/cc to 1.50 g/cc.

In an embodiment, the PSA is selected from an acrylic-based PSA, an acrylic-hybrid PSA, a rubber-based PSA, and combinations thereof; and the adhesive layer has a thickness of from 1 mil to 5 mil, or from 1 mil to 4 mil, or from 1 to 3 mil, or from 1 to 2 mil, or from 2 mil to 5 mil, or from 2 mil to 4 mil, or from 2 mil to 3 mil, or from 5 mil to 15 mil, or from 6 mil to 14 mil, or from 6 mil to 10 mil, or from 10 mil to 15 mil, or from 10 mil to 14 mil. In a further embodiment, the PSA has a density of from 0.840 g/cc to 1.80 g/cc, or from 0.850 g/cc to 1.50 g/cc, or from 0.850 g/cc to 0.90 g/cc, or from 0.850 g/cc to 0.870 g/cc, or from 1.00 g/cc to 1.50 g/cc, or from 1.30 g/cc to 1.50 g/cc.

The floor marking tape may include one or more adhesive layers. The composition and properties of each adhesive layer may be the same or different. For example, the floor marking tape may have a first adhesive layer and a second adhesive layer. In a first embodiment, each of the first and second adhesive layers may be formed from an identical PSA composition and have identical thicknesses. In a second embodiment, the first adhesive layer may be formed from a different PSA composition than the second adhesive layer, and each of the first and second adhesive layers may have identical thicknesses. In a third embodiment, the first adhesive layer may be formed from a different PSA composition than the second adhesive layer, and the first and second adhesive layers may have different thicknesses relative to each other.

In an embodiment, the floor marking tape has a single, or one and only one, adhesive layer. The adhesive layer contacts the top layer. In a further embodiment, the adhesive layer directly contacts the top layer.

In an embodiment, the floor marking tape has at least two adhesive layers (which may be the same or different in composition and thickness). At least one of the adhesive layers is configured to be the bottom layer of the floor marking tape. The bottom layer is the layer proximate to a substrate when the floor marking tape is applied to the substrate (e.g., a factory floor, store floor, etc.).

In an embodiment, the floor marking tape includes a first adhesive layer and a second adhesive layer, the second adhesive layer being the bottom layer of the floor marking tape. The first adhesive layer contains a first PSA that is selected from an acrylic-based PSA, an acrylic-hybrid PSA, a rubber-based PSA, and combinations thereof. The second adhesive layer contains a second PSA that is selected from an acrylic-based PSA, an acrylic-hybrid PSA, a rubber-based PSA, and combinations thereof. In a further embodiment, the second PSA is a rubber-based PSA. The first PSA and the second PSA may be the same or different. In an embodiment, the first PSA and the second PSA are the same. In another embodiment, the first PSA and the second PSA are different.

The adhesive layer may comprise two or more embodiments disclosed herein.

C. Intermediate Layer

In an embodiment, the floor marking tape includes an intermediate layer including a polymer in contact with a first adhesive layer, the first adhesive layer in contact with the top layer. In a further embodiment, the intermediate layer contacts a second adhesive layer. An “intermediate layer” is a non-surface layer that is located between two adhesive layers.

The intermediate layer may directly or indirectly contact the top layer.

The intermediate layer may directly or indirectly contact the second adhesive layer.

The intermediate layer has a top facial surface and an opposing bottom facial surface.

The intermediate layer includes a polymer. Nonlimiting examples of suitable polymers include polyolefins, polyamides, vinyl polymers, and polyesters. The polyolefin, polyamide, and vinyl polymer may be any respective polyolefin, polyamide, and vinyl polymer disclosed herein. The polymer in the top layer may be the same as or different than the polymer in the intermediate layer. In an embodiment, the polymer in the top layer is different than the polymer in the intermediate layer.

In an embodiment, the intermediate layer includes a polymeric composition containing the polymer and an optional additive. The optional additive may be any optional additive disclosed herein.

In an embodiment, the polymer is a polyester. A nonlimiting example of a suitable polyester is PET. A nonlimiting example of a suitable PET intermediate layer is Skyrol SH82, a PET film.

In an embodiment, the intermediate layer is translucent.

In an embodiment, the intermediate layer has a thickness of from 1 mil, or 2 mil to 3 mil, or 4 mil, or 5 mil, or 6 mil, or 10 mil, or 12 mil, or 14 mil, or 15 mil. In another embodiment, the intermediate layer has a thickness of from 1 mil to 15 mil, or from 1 mil to 10 mil, or from 1 mil to 5 mil, or from 2 mil to 4 mil, or from 3 mil to 4 mil, or from 2 mil to 3 mil.

In an embodiment, the polymer is PET and the intermediate layer has a thickness of from 1 mil to 15 mil, or from 1 mil to 10 mil, or from 1 mil to 5 mil, or from 2 mil to 4 mil, or from 3 mil to 4 mil, or from 2 mil to 3 mil.

In an embodiment, the intermediate layer has a substantially uniform thickness from each edge surface to the opposing edge surface. In an intermediate layer having substantially uniform thickness from each edge surface to the opposing edge surface, the top facial surface and the opposing bottom facial surface extend parallel to each other.

In some embodiments, the intermediate layer is chemically treated or print-treated to promote adhesion to its top and/or bottom facial surface.

Not wishing to be bound by any particular theory, it is believed that the presence of the intermediate layer provides rigidity to the floor marking tape, which can make the floor marking tape easier for a user to apply to a substrate. Rigidity can also improve the overall durability of the floor marking tape.

The intermediate layer may comprise two or more embodiments disclosed herein.

D. Optional Release Liner

In an embodiment, the floor marking tape includes an optional release liner. The optional release liner directly contacts an adhesive layer.

Nonlimiting examples of release liners include glassine paper, laminated paper, differential release liner, polyester film, and polypropylene film, each of which may or may not have been subjected to a coating of silicone.

In one embodiment the floor marking tape is void of a release liner. In this embodiment the release liner may or may not be replaced with a release coating, e.g., a silicone-based or wax-based material.

The release liner is removed from the floor marking tape before it is applied to a substrate.

The release liner has a top facial surface and an opposing bottom facial surface.

In an embodiment, the release liner has a thickness of from 0.5 mil, or 1 mil, or 2 mil to 3 mil, or 4 mil, or 5 mil, or 6 mil, or 10 mil, or 12 mil, or 14 mil, or 15 mil. In another embodiment, the release liner has a thickness of from 0.5 mil to 15 mil, or from 1 mil to 10 mil, or from 1 mil to 5 mil, or from 2 mil to 4 mil, or from 3 mil to 4 mil, or from 2 mil to 3 mil.

The optional release liner may comprise two or more embodiments disclosed herein.

E. Optional Pigment Layer

In an embodiment, the floor marking tape includes an optional pigment layer. The optional pigment layer contains a pigment.

A nonlimiting example of a suitable pigment is ink. A nonlimiting example of a suitable ink is flexographic ink.

The pigment layer is a non-surface layer that contacts the top layer. The pigment layer may directly or indirectly contact the top layer.

The pigment layer may directly or indirectly contact the first adhesive layer.

The pigment layer may directly or indirectly contact the intermediate layer.

In an embodiment, the pigment layer directly contacts the top layer and the first adhesive layer, the first adhesive layer directly contacting an intermediate layer. In a further embodiment, the intermediate layer directly contacts a second adhesive layer.

In another embodiment, the pigment layer directly contacts the first adhesive layer and the intermediate layer. The first adhesive layer directly contacts the top layer. In a further embodiment, the intermediate layer directly contacts a second adhesive layer.

The pigment layer has a top facial surface and an opposing bottom facial surface.

The pigment layer may include the pigment and an optional additive. The optional additive may be any optional additive disclosed herein.

In an embodiment, the pigment layer is an ink layer containing a flexographic ink.

In an embodiment, the pigment layer has a substantially uniform thickness from each edge surface to the opposing edge surface. In a pigment layer having substantially uniform thickness from each edge surface to the opposing edge surface, the top facial surface and the opposing bottom facial surface extend parallel to each other. In an embodiment, the thickness of the pigment layer is from greater than 0 mils to less than 0.01 mils, or less than 0.001 mils, or less than 0.0001 mils.

In an embodiment, the pigment layer is a non-surface layer that contacts the top layer.

In another embodiment, the pigment layer is in the form of a graphic image, such as a pattern (e.g., striped, dotted, etc.), indicia, or text. For example, the graphic image may be text that says “DO NOT ENTER—DANGER” and the floor marking tape may be used to indicate a dangerous area within a factory setting. In another instance, the graphic image may be the image of a face mask and the floor marking tape may be used on the floor of a retail store to demonstrate to customers a safe distance to stand next to each other.

The optional pigment layer may comprise two or more embodiments disclosed herein.

F. Floor Marking Tape

The present disclosure provides floor marking tape having a total thickness of less than 40 mil (1.016 mm).

In an embodiment, the total thickness of the floor marking tape excludes the thickness of the optional release liner.

In an embodiment, the floor marking tape has a total thickness of less than 40 mil, or less than 35 mil, or less than 33 mil, or less than 30 mil. In another embodiment, the floor marking tape has a total thickness of from 15 mil, or 17 mil, or 18 mil, or 20 mil, or 22 mil, or 24 mil to 25 mil, or 28 mil, or 30 mil, or 32 mil, or 35 mil, or 38 mil, or 39 mil. In a further embodiment, the floor marking tape has a total thickness of from 15 mil to less than 40 mil, or from 15 mil to 39 mil, or from 17 mil to 35 mil, or from 22 mil to 35 mil, or from 22 mil to 30 mil, or from 22 mil to 25 mil, or from 23 mil to 32 mil, or from 24 mil to 32 mil, or from 28 mil to 32 mil.

In an embodiment, the floor marking tape includes (A) the top layer including a polymer having a flexural strength of greater than 2,100 psi (14.48 MPa) and (B) the adhesive layer including a PSA in contact with the top layer. In a further embodiment, the floor marking tape has the following Structure I.
Top Layer/Adhesive Layer (Structure I).

In an embodiment, the floor marking tape has the Structure I, and the floor marking tape has a total thickness of from 22 mil to 34 mil, or from 24 mil to 32 mil, or from 22 mil to 30 mil, or from 22 mil to 26 mil. In a further embodiment, the polymer is a polyamide. In a further embodiment, the PSA is a rubber-based PSA containing butyl rubber.

In an embodiment, the floor marking tape has the Structure I, and the floor marking tape has a total thickness of from 22 mil to 34 mil, or from 24 mil to 32 mil, or from 22 mil to 30 mil, or from 22 mil to 26 mil. In a further embodiment, the polymer is selected from HDPE, PVC, PVDF, a polyamide, and polypropylene. In some embodiments, the polymer is HDPE. In a further embodiment, the PSA is selected from a rubber-based PSA and an acrylic-hybrid PSA.

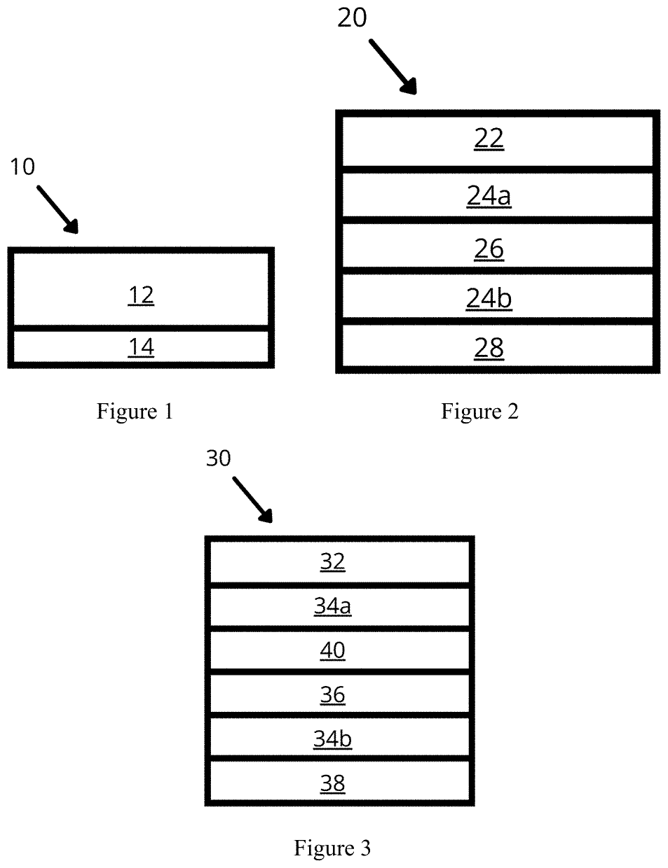

FIG. 1 is a schematic of a floor marking tape having the Structure I. The floor marking tape 10 has a top layer 12 and an adhesive layer 14. The top layer 12 directly contacts the adhesive layer 14.

In an embodiment, the floor marking tape having a total thickness of less than 40 mil (1.016 mm) includes (A) the top layer including a polymer having a flexural strength of greater than 2,100 psi (14.48 MPa); (B) the adhesive layer including a PSA in contact with the top layer; and (C) an optional release liner in direct contact with the adhesive layer. In a further embodiment, the floor marking tape has the following Structure II.
Top Layer/Adhesive Layer/Optional Release Liner (Structure II).

In an embodiment, the floor marking tape has the Structure II, and the floor marking tape has a total thickness of from 22 mil to 34 mil, or from 24 mil to 32 mil, or from 22 mil to 30 mil, or from 22 mil to 26 mil. In a further embodiment, the polymer is a polyamide. In a further embodiment, the PSA is a rubber-based PSA containing butyl rubber.

In an embodiment, the floor marking tape has the Structure II, and the floor marking tape has a total thickness of from 22 mil to 34 mil, or from 24 mil to 32 mil, or from 22 mil to 30 mil, or from 22 mil to 26 mil. In a further embodiment, the polymer is selected from HDPE, PVC, PVDF, a polyamide, and polypropylene. In some embodiments, the polymer is HDPE. In a further embodiment, the PSA is selected from a rubber-based PSA and an acrylic-hybrid PSA.

In an embodiment, the floor marking tape having a total thickness of less than 40 mil (1.016 mm) includes (A) the top layer including a first polymer having a flexural strength of greater than 2,100 psi (14.48 MPa); (B) the first adhesive layer including a first PSA in contact with the top layer; (C) the intermediate layer including a second polymer in contact with the first adhesive layer; and (D) the second adhesive layer including a second PSA in contact with the intermediate layer. In a further embodiment, the floor marking tape has the following Structure III: Top Layer/First Adhesive Layer/Intermediate Layer/Second Adhesive Layer (Structure III).

In an embodiment, the floor marking tape has the Structure III, and the floor marking tape has a total thickness of from 20 mil to 30 mil, or from 22 mil to 28 mil, or from 22 mil to 25 mil. In a further embodiment, the first polymer is selected from HDPE, PVC, PVDF, PCTG, PETG, a polyamide, and polypropylene. In a further embodiment, the first PSA is selected from an acrylic-hybrid PSA, an acrylic-based PSA, a rubber-based PSA, and combinations thereof. In some embodiments, the second polymer is a polyester, or further a PET. In a further embodiment, the second PSA is a rubber-based PSA.

In an embodiment, the floor marking tape has the Structure III, and the floor marking tape has a total thickness of from 20 mil to 30 mil, or from 22 mil to 28 mil, or from 22 mil to 25 mil. In a further embodiment, the first polymer is selected from HDPE, PVC, PVDF, a polyamide, and polypropylene. In a further embodiment, the first PSA is an acrylic-hybrid PSA. In some embodiments, the second polymer is a polyester, or further a PET. In a further embodiment, the second PSA is a rubber-based PSA.

In an embodiment, the floor marking tape has the Structure III, and the floor marking tape has a total thickness of from 20 mil to 30 mil, or from 22 mil to 28 mil, or from 22 mil to 25 mil. In a further embodiment, the first polymer is selected from HDPE, PVC, PVDF, a polyamide, and polypropylene. In a further embodiment, the first PSA is an acrylic-based PSA. In some embodiments, the second polymer is a polyester, or further a PET. In a further embodiment, the second PSA is a rubber-based PSA.

In an embodiment, the floor marking tape has the Structure III, and the floor marking tape has a total thickness of from 20 mil to 30 mil, or from 22 mil to 28 mil, or from 22 mil to 25 mil. In a further embodiment, the first polymer is selected from PCTG and PETG. In a further embodiment, the first PSA is an acrylic-based PSA. In some embodiments, the second polymer is a polyester, or further a PET. In a further embodiment, the second PSA is a rubber-based PSA.

In an embodiment, the floor marking tape has the Structure III, and the floor marking tape has a total thickness of from 20 mil to 30 mil, or from 22 mil to 28 mil, or from 22 mil to 25 mil. In a further embodiment, the first polymer is selected from PCTG and PETG. In a further embodiment, the first PSA is an acrylic-hybrid PSA. In some embodiments, the second polymer is a polyester, or further a PET. In a further embodiment, the second PSA is a rubber-based PSA.

In an embodiment, the floor marking tape has the Structure III, and the floor marking tape has a total thickness of from 20 mil to 30 mil, or from 22 mil to 28 mil, or from 22 mil to 25 mil. In a further embodiment, the first polymer is selected from PCTG and PETG. In a further embodiment, the first PSA is a first rubber-based PSA. In some embodiments, the second polymer is a polyester, or further a PET. In a further embodiment, the second PSA is a second rubber-based PSA. The first rubber-based PSA and the second rubber-based PSA may be the same or different.

In an embodiment, the first rubber-based PSA and the second rubber-based PSA are the same. In an embodiment, the floor marking tape having a total thickness of less than 40 mil (1.016 mm) includes (A) the top layer including a first polymer having a flexural strength of greater than 2,100 psi (14.48 MPa); (B) the first adhesive layer including a first PSA in contact with the top layer; (C) the intermediate layer including a second polymer in contact with the first adhesive layer; (D) the second adhesive layer including a second PSA in contact with the intermediate layer; and (E) an optional release liner in contact with the second adhesive layer. In a further embodiment, the floor marking tape has the following Structure IV:
Top Layer/First Adhesive Layer/Intermediate Layer/Second Adhesive Layer/Optional Release Liner (Structure IV).

In an embodiment, the floor marking tape has the Structure IV, and the floor marking tape has a total thickness of from 20 mil to 30 mil, or from 22 mil to 28 mil, or from 22 mil to 25 mil. In a further embodiment, the first polymer is selected from HDPE, PVC, PVDF, PCTG, PETG, a polyamide, and polypropylene. In a further embodiment, the first PSA is selected from an acrylic-hybrid PSA, an acrylic-based PSA, a rubber-based PSA, and combinations thereof. In some embodiments, the second polymer is a polyester, or further a PET. In a further embodiment, the second PSA is a rubber-based PSA.

In an embodiment, the floor marking tape has the Structure IV, and the floor marking tape has a total thickness of from 20 mil to 30 mil, or from 22 mil to 28 mil, or from 22 mil to 25 mil. In a further embodiment, the first polymer is selected from HDPE, PVC, PVDF, a polyamide, and polypropylene. In a further embodiment, the first PSA is an acrylic-hybrid PSA. In some embodiments, the second polymer is a polyester, or further a PET. In a further embodiment, the second PSA is a rubber-based PSA.

In an embodiment, the floor marking tape has the Structure IV, and the floor marking tape has a total thickness of from 20 mil to 30 mil, or from 22 mil to 28 mil, or from 22 mil to 25 mil. In a further embodiment, the first polymer is selected from HDPE, PVC, PVDF, a polyamide, and polypropylene. In a further embodiment, the first PSA is an acrylic-based PSA. In some embodiments, the second polymer is a polyester, or further a PET. In a further embodiment, the second PSA is a rubber-based PSA.

FIG. 2 is a schematic of an embodiment of a floor marking tape having the Structure IV. The floor marking tape 20 has a top layer 22, a first adhesive layer 24a, an intermediate layer 26, a second adhesive layer 24b, and a release liner 28. In the embodiment depicted in FIG. 2, each layer directly contacts the adjacent layer. However, it is understood that in an alternate embodiment, one or more of the layers of Structure IV may instead indirectly contact an adjacent layer.

In an embodiment, the floor marking tape having a total thickness of less than 40 mil (1.016 mm) includes (A) the top layer including a first polymer having a flexural strength of greater than 2,100 psi (14.48 MPa); (B) the first adhesive layer including a first PSA in contact with the top layer; (C) a pigment layer in contact with the first adhesive layer; (D) the intermediate layer including a second polymer in contact with the pigment layer; (E) the second adhesive layer including a second PSA in contact with the intermediate layer; and (F) an optional release liner in contact with the second adhesive layer. In a further embodiment, the floor marking tape has the following Structure V:
Top Layer/First Adhesive Layer/Pigment Layer/Intermediate Layer/Second Adhesive Layer/Optional Release Liner (Structure V).

In an embodiment, the floor marking tape has the Structure V, and the floor marking tape has a total thickness of from 20 mil to 30 mil, or from 22 mil to 28 mil, or from 22 mil to 24 mil. In a further embodiment, the first polymer is selected from HDPE, PVC, PVDF, PCTG, PETG, a polyamide, and polypropylene. In another embodiment, the first polymer is selected from PCTG, PETG, and combinations thereof. In a further embodiment, the first PSA is selected from an acrylic-hybrid PSA, an acrylic-based PSA, a rubber-based PSA, and combinations thereof. In some embodiments, the second polymer is a polyester, or further a PET. In a further embodiment, the second PSA is a rubber-based PSA.

In an embodiment, the floor marking tape has the Structure V, and the floor marking tape has a total thickness of from 20 mil to 30 mil, or from 22 mil to 28 mil, or from 22 mil to 24 mil. In a further embodiment, the first polymer is selected from PCTG and PETG. In some embodiments, the top layer is transparent. In a further embodiment, the first PSA is selected from an acrylic-hybrid PSA, an acrylic-based PSA, a rubber-based PSA, and combinations thereof. In some embodiments, the second polymer is a polyester, or further a PET. In a further embodiment, the second PSA is a rubber-based PSA.

FIG. 3 is a schematic of an embodiment of a floor marking tape having the Structure V. The floor marking tape 30 has a top layer 32, a first adhesive layer 34a, a pigment layer 40, an intermediate layer 36, a second adhesive layer 34b, and a release liner 38. In the embodiment depicted in FIG. 3, each layer directly contacts the adjacent layer. However, it is understood that in an alternate embodiment, one or more of the layers of Structure V may instead indirectly contact an adjacent layer.

The structures depicted in FIGS. 1-3 are schematics that are not intended to represent the relative thickness of each layer with respect to the other layers.

In an embodiment, the floor marking tape having a total thickness of less than 40 mil (1.016 mm) includes (A) the top layer including a first polymer having a flexural strength of greater than 2,100 psi (14.48 MPa); (B) a pigment layer in contact with the top layer; (C) the first adhesive layer including a first PSA in contact with the pigment layer; (D) the intermediate layer including a second polymer in contact with the first adhesive layer; (E) the second adhesive layer including a second PSA in contact with the intermediate layer; and (F) an optional release liner in contact with the second adhesive layer. In a further embodiment, the floor marking tape has the following Structure VI:
Top Layer/Pigment Layer/First Adhesive Layer/Intermediate Layer/Second Adhesive Layer/Optional Release Liner (Structure VI).

In an embodiment, the floor marking tape has the Structure VI, and the floor marking tape has a total thickness of from 20 mil to 30 mil, or from 22 mil to 28 mil, or from 22 mil to 25 mil. In a further embodiment, the first polymer is selected from HDPE, PVC, PVDF, PCTG, PETG, a polyamide, and polypropylene. In another embodiment, the first polymer is selected from PCTG, PETG, and combinations thereof. In a further embodiment, the first PSA is selected from an acrylic-hybrid PSA, an acrylic-based PSA, a rubber-based PSA, and combinations thereof. In some embodiments, the second polymer is a polyester, or further a PET. In a further embodiment, the second PSA is a rubber-based PSA.

It is understood that the total thickness of the floor marking tape of Structures I-VI exclude the thickness of the optional release liner. In Structures I-VI, the adjacent layers directly or indirectly contact each other. In some embodiments, in Structures I-VI, the adjacent layers directly contact each other. In some embodiments, each layer has substantially uniform thickness from each edge surface to the opposing edge surface. In another embodiment, each of the top layer, the first adhesive layer, the intermediate layer, the second adhesive layer, and the optional release liner has substantially uniform thickness from each edge surface to the opposing edge surface, while the optional pigment layer may or may not have substantially uniform thickness from each edge surface to the opposing edge surface.

In some embodiments, the floor marking tape may include additional alternating adhesive layers and intermediate layers. In such embodiments, it is understood that the bottom layer of the floor marking tape is an adhesive layer.

In an embodiment, the floor marking tape is void of, or substantially void of PVC.

The top layer and the intermediate layer may be formed by extrusion. In some embodiments, the top layer and the intermediate layer are co-extruded, with or without an adhesive layer between the two layers. In another embodiment, the top layer and the intermediate layer are separately formed via extrusion. Optional additives in either of the top layer or the intermediate layer (such as pigments) may be added during compounding prior to extrusion, or they may be added inline during extrusion. Each of the top layer and the intermediate layer is a film. The film may be a single layer film or a multilayer film. In an embodiment, the top layer and the intermediate layer each is a single layer film.

In some embodiments, the adhesive layer is applied to the top layer and/or the intermediate layer via slot die coating. The coated layer is then exposed to heat and convective air movement to remove, or substantially remove, solvent and/or water that may be present in the PSA. The slot die coating and heat/air movement exposure steps may be repeated until the desired thickness of the adhesive layer is attained.

In some embodiments, the adhesive layer is hot-melt coated on the top layer and/or the intermediate layer. During hot-melt coating, the PSA is placed in a drum unloader, in which the PSA is heated to a target temperature. The PSA is then pumped to a melt tank with a controlled temperature and volume level. A coating head pumps the PSA from the melt tank at a constant rate to maintain a constant layer thickness. The coated layer is then cooled to room temperature.

In an embodiment, a sheet is formed as described above. Then, the sheet is sliced into strips or the desired shape to form the floor marking tape.

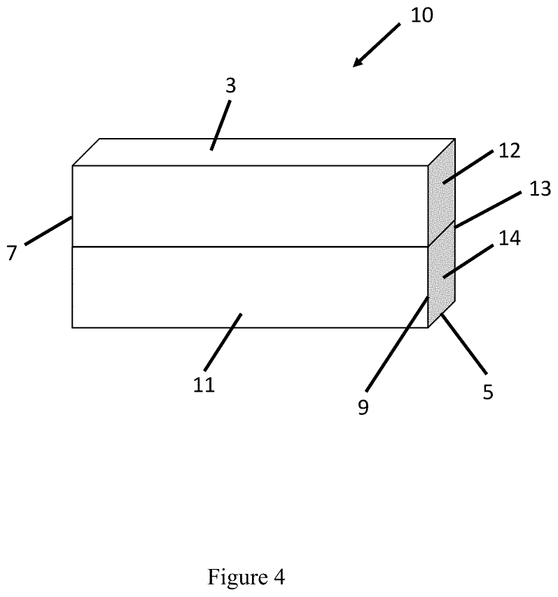

In an embodiment, as shown in FIG. 4, the floor marking tape 10 has a top facial surface 3 and an opposing bottom facial surface 5. The floor marking tape 10 has a front edge surface 7 and an opposing rear edge surface 9. The floor marking tape has a left edge surface 11 and an opposing right edge surface 13. A layer that has substantially uniform thickness has substantially the same thickness extending from the front edge surface 7 to the opposing rear edge surface 9, and from the left edge surface 11 to the opposing right edge surface 13.

The present floor marking tape is suitable for being applied to a substrate, such as a floor or walkway formed from sealed concrete, unsealed concrete, tile, linoleum, wood, metal, cardboard, and the like. The present floor marking tape is suitable for both indoor and outdoor use. In some embodiments, the top facial surface 3 of the floor marking tape 10 contains a graphic image. For example, the graphic image may be text that says “DO NOT ENTER—DANGER” and the floor marking tape may be used to indicate a dangerous area within a factory setting. In another instance, the graphic image may be the image of a face mask and the floor marking tape may be used on the floor of a retail store to demonstrate to customers a safe distance to stand next to each other.

In some instances, the floor marking tape is rolled onto itself to form a roll. In other instances, the floor marking tape may be cut into a desired shape, such as a circle or the outline of on object (e.g., the outline of a person, a car, or a bicycle).

The floor marking tape may comprise two or more embodiments disclosed herein.

By way of example, and not limitation, examples of the present disclosure are provided.

### Examples

### Materials

The materials used in the examples are provided in Table 1.

TABLE 1

| Name | Description | Source |
|---|---|---|
| PVC #1 | polymeric composition containing 64.6 wt % | N/A |
| | PVC, 23.75 wt % plasticizer, 2.85 wt % titanium | |
| | dioxide, 5 wt % yellow pigment, and 3.8 wt % | |
| | heat stabilizer*; density = 1.34 g/cc | |
| PVC #2 | polymeric composition containing 60.8 wt % | N/A |
| | PVC, 9.5 wt % filler, 18.05 wt % plasticizer, 2.85 | |
| | wt % titanium dioxide, 5 wt % yellow pigment, | |
| | and 3.8 wt % heat stabilizer*; density = 1.44 g/cc | |
| PVC #3 | polymeric composition containing 72.2 wt % | N/A |
| | PVC, 16.15 wt % plasticizer, 2.85 wt % titanium | |
| | dioxide, 5 wt % yellow pigment, and 3.8 wt % | |
| | heat stabilizer*; density = 1.38 g/cc | |
| Red PVC | 2-inch red solid color film, 100-foot roll; | Mighty Line Floor |
| | adhesive-less; PVC film with red pigment; 42 | Tape |
| | mil thick | |
| Skyrol SH82 | PET film; 300 Gauge; 3 mil (75 μm) thickness | SKC |
| RTP 700 ABR | HDPE; density = 0.95 g/cc | RTP Company |
| RTP 200 A ABR | Nylon 6 (polyamide); density = 1.06 g/cc | RTP Company |
| SKYGREEN JN200 | PCTG; density = 1.23 g/cc | SK Chemicals |
| ECOZEN T110 Plus | PETG; density = 1.25 g/cc | SK Chemicals |
| B-483A | Glossy yellow multi-layer film containing a | Brady Corporation |
| | white polyester layer (thickness = 2 mil) in | |
| | contact with a rubber-based PSA (thickness = 2 | |
| | mil); total thickness = 4 mil | |
| VERSIFY 3000 | Polyolefin plastomer; density = 1.23 g/cc | The Dow Chemical |
| | | Company |
| MORSTIK 123 | Synthetic rubber-based PSA; solvent-based; | The Dow Chemical |
| | density = 0.863 g/cc | Company |
| Thermogrip 9492KN | rubber-based PSA containing butyl rubber; | Bostik |
| | density = 1.4 g/cc | |
| LOCTITE DURO-TAK | acrylic-based PSA; solvent-based; | Henkel |
| 230A | density = 0.851 g/cc | |
| LOCTITE DURO-TAK | acrylic-rubber PSA; solvent-based; | Henkel |
| AH 115 | density = 0.869 g/cc | |

*wt % is based on the total weight percent of the polymeric composition.

The properties of the PVC Compositions 1-3, RTP 700 ABR, RTP 200 A ABR, Skygreen JN200, Ecozen Ti 10 Plus, and Versify 3000 are measured in accordance with the test methods provided above, and the results are reported in Table 2. Flexural strength and tensile strength are measured on at least six samples of extruded film at varying thicknesses (from 15 mil to 42 mil, and the mean is reported as the measured value in Table 2). In Table 2, “SR” means the value was reported by the supplier.

CS 1 is a comparative tape obtained from Brady Worldwide, Inc.: the ToughStripe Max Solid Colored Tape (color green, 2-inch×100-foot roll) (Material Number B-543/Part Number 149632), which has an extruded PVC top layer and an adhesive layer containing an acrylic-based PSA. CS 1 has a total thickness of 46.1 mil (excluding a 3.6 mil thick release liner). CS 1 is cut into 2-inch×2-foot samples.

CS 2 is a comparative tape obtained from Brady Worldwide, Inc.: the Solid Colored ToughStripe Tape (color blue, 2-inch×100-foot roll) (Material Number B-514/Part Number 104314), which has a polyester top layer (with a clear polyester overlaminate) and an adhesive layer containing a rubber-based PSA. CS 2 has a total thickness of 8 mils. CS 2 is cut into 2-inch×2-foot samples.

CS 3 is a comparative tape obtained from Brady Worldwide, Inc.: the ToughStripe Max Solid Colored Tape (color orange, 2-inch×100-foot roll) (Material Number B-543/Part Number 149635), which has an extruded PVC top layer and an adhesive layer containing an acrylic-based PSA. CS 3 has a total thickness of 46.1 mil (excluding a 3.6 mil thick release liner). CS 3 is cut into 2-inch×2-foot samples.

TABLE 2

| | Flexural Strength | | Tensile Strength | | Shore | Rockwell | Storage Modulus |
|---|---|---|---|---|---|---|---|
| | (psi) | | (psi) | | D | (R) | (G′) (MPa) |
| Material | Measured | SR | Measured | SR | SR | SR | Measured |
| PVC #1 | 299.4 | 350 | — | 3077 | 48.2 | — | 200 |
| PVC #2 | 2439.0 | 2454 | — | 3310 | 74 | — | 1250 |
| PVC #3 | 5188.5 | 5302 | — | 3762 | 78 | — | 1900 |
| Red PVC | 1165.3 | — | 4835 | — | 60 | — | 500 |
| RTP 700 | 3073.8 | 3500 | 4342.1 | 3600 | 68 | — | 1500 |
| ABR | | | | | | | |
| RTP 200 A | — | 10000 | — | 6500 | — | — | — |
| ABR | | | | | | | |
| SKYGREEN | 7490 | 9715 | 7688 | 7685 | — | 105 | 1775 |
| JN200 | | | | | | | |
| ECOZEN | 7881 | 11521 | 7698 | 7538 | — | >115 | 1827 |
| T110 Plus | | | | | | | |
| VERSIFY | 2030 | — | 5001 | 3960 | 60 | — | 7.5 |
| 3000 | | | | | | | |

### Structure IV Examples

Examples having the Structure IV disclosed above and depicted in FIG. 2 are formed using the materials of Tables 1 and 2. The second PSA is coated onto the bottom facial surface of the Skyrol SH82 PET film (3 mil thick) via slot die coating and are then exposed to heat and convective air movement to form the second adhesive layer (2 mil thick), and is then laminated with glassine paper (a release liner). The top facial surface of the Skyrol SH82 PET film is then coated with the first PSA via slot die coating and are then exposed to heat and convective air movement to form the first adhesive layer (2 mil thick), and is then laminated with a top layer.

The top layers are formed in a three-roll stack extrusion process using a Wiman extruder to produce rollform-extruded polymer film. The middle roller is chrome, which imparts a high gloss finish to the film. In Round 2 (explained in detail below) R^{M}, the chrome roller was replaced with an embossing roller to impart a matte finish to the film.

For the examples used in Round 1 (explained in detail below), the layers were hand-laminated using a 4.5-pound roller. The hand-laminated constructions were then cut with scissors into 2-inch×2-foot floor marking tapes for testing. The release liner is removed before placement of the floor marking tape example onto a substrate.

For the examples used in Round 2 (explained in detail below), the layers were laminated wide-web using a lamination nip under pressure. The release liner was removed before the top layer was laminated to the first adhesive layer. The wide-web laminated constructions having a 46-inch width were slit industrially to form floor marking tapes having widths of 2-inches, 4-inches, and 24-inches-each having a length of 288 yards. From the tapes having a width of 2-inches, samples were cut into 2-inch×2-foot floor marking tapes for testing.

For each example, the thickness of the first adhesive layer (2 mil), the intermediate layer (3 mil), and the second adhesive layer (2 mil) is the same. Each layer has substantially uniform thickness from edge-to-edge. A summary of the structure of each Structure IV example floor marking tape is provided below in Table 3.

TABLE 3

| | | Top | | | Total |
|---|---|---|---|---|---|
| | | Layer | | | Tape |
| | Top | Thick- | First | Second | Thick- |
| | Layer | ness | Adhesive | Adhesive | ness |
| Ex. | Polymer | (mil) | Layer | Layer | (mil) |
| A | PVC #1 | 40 | 230A** | MORSTIK 123 | 47 |
| B | PVC #2 | 40 | 230A** | MORSTIK 123 | 47 |
| C | PVC #3 | 40 | 230A** | MORSTIK 123 | 47 |
| D | PVC #1 | 25 | 230A** | MORSTIK 123 | 32 |
| E | PVC #2 | 25 | 230A** | MORSTIK 123 | 32 |
| F | PVC #3 | 25 | 230A** | MORSTIK 123 | 32 |
| G | PVC #1 | 20 | 230A** | MORSTIK 123 | 27 |
| H | PVC #2 | 20 | 230A** | MORSTIK 123 | 27 |
| I | PVC #3 | 20 | 230A** | MORSTIK 123 | 27 |
| J | RTP 700 ABR | 20 | 230A** | MORSTIK 123 | 27 |
| K | PVC #1 | 15 | 230A** | MORSTIK 123 | 22 |
| L | PVC #2 | 15 | 230A** | MORSTIK 123 | 22 |
| M | PVC #3 | 15 | 230A** | MORSTIK 123 | 22 |
| N | RTP 700 ABR | 15 | 230A** | MORSTIK 123 | 22 |
| O | RTP 700 ABR | 15 | AH 115* | MORSTIK 123 | 22 |
| P | RTP 200 A ABR | 15 | AH 115* | MORSTIK 123 | 22 |
| Q | RTP 700 ABR | 20 | AH 115* | MORSTIK 123 | 27 |
| R | RTP 700 ABR | 18 | AH 115* | MORSTIK 123 | 25 |
| R^{M} | RTP 700 ABR | 18 | AH 115* | MORSTIK 123 | 25 |
| S | RTP 700 ABR | 17 | AH 115* | MORSTIK 123 | 24 |
| T | RTP 700 ABR | 16 | AH 115* | MORSTIK 123 | 23 |
| U | Red PVC | 42 | 230A** | MORSTIK 123 | 49 |

*LOCTITE DURO-TAK AH 115
**LOCTITE DURO-TAK 230A

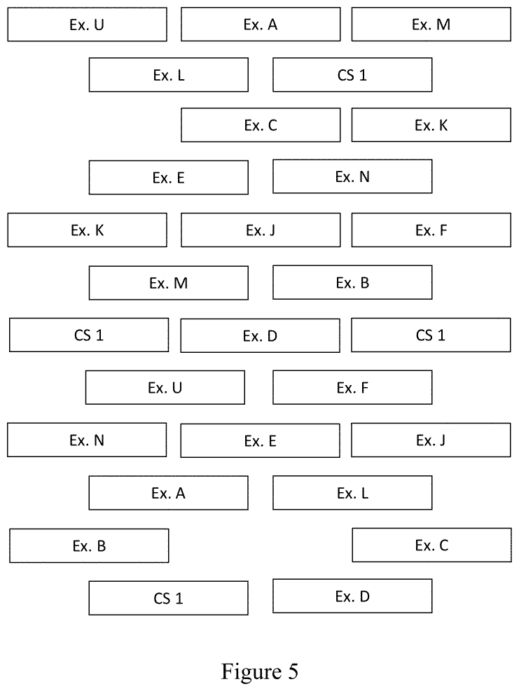

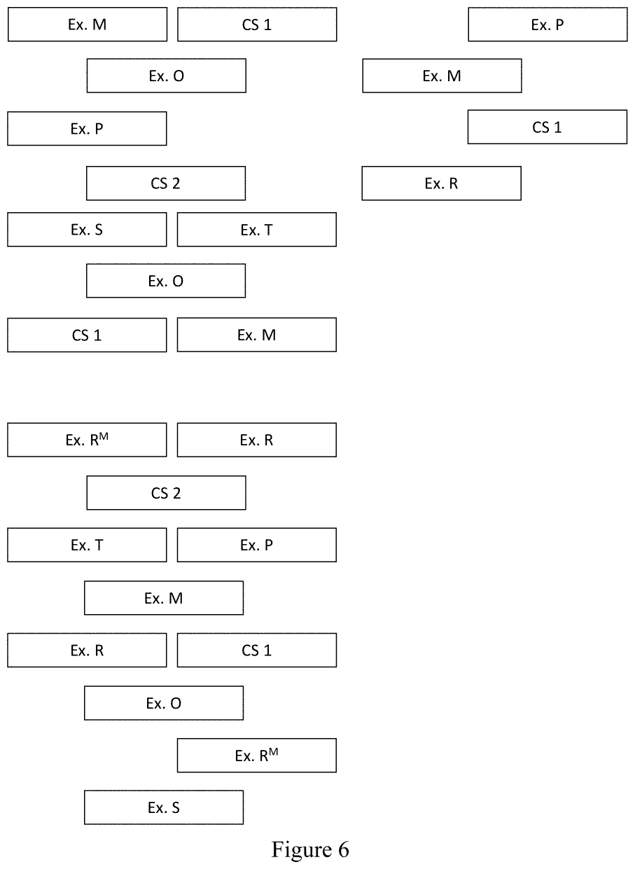

Round 1: Example 2-inch×2-foot floor marking tapes produced as described above were placed in an operations receiving dock on a factory floor in the configuration depicted in FIG. 5. The area is a crossroads of pallet, forklift, cart, and foot traffic. To account for certain areas of the floor being subject to more traffic than others, at least two samples of each example were placed on the factory floor in a non-randomized fashion. The floor is formed from sealed concrete.

Round 2: The areas of lower relative traffic were identified following Round 1. Example 2-inch×2-foot floor marking tapes produced as described above were placed in the identified high traffic areas of the operations receiving dock on the factory floor in the configuration depicted in FIG. 6.

For both Round 1 and Round 2, photographs were taken on a weekly basis to monitor deterioration. During Round 2, a video camera was used to monitor for special cause-event analysis. Results are evaluated by visual assessment for tape loss and the type of failure mode (i.e., whether the top layer failed and/or the adhesive failed). For instance, if the intermediate layer is visible and the top layer is missing, that indicates an adhesive-to-polymer bond failure mode.

### Structure II Examples

Examples having the Structure II disclosed above are formed using the materials of Tables 1 and 2. Structure II includes the top layer 12 and adhesive layer 14 depicted in FIG. 1, with the addition of a release liner 28 in contact with the adhesive layer 14.

The top layers are formed in a three-roll stack extrusion process using a Wiman extruder to produce rollform-extruded polymer film. The middle roller is chrome, which imparts a high gloss finish to the film.

An adhesive is coated onto a differential release liner via slot die coating and is then exposed to heat and convective air movement to form an adhesive layer (2 mil thick). The adhesive layer/release liner structure is then laminated with a top layer, such that the adhesive layer directly contacts the top layer.

The layers were laminated wide-web using a lamination nip under pressure with an ELS industrial converting machine. The ELS industrial converting machine is set to a line speed of 75 feet per minute (FPM), an unwind tension of 25-30 lbs, an air pressure of 12-24 psi, a rewind tension of 700-800 lbs, a rewind taper tension of 100%, a nip pressure of 60 psi, and a lay on roll pressure of 25 psi.

The wide-web laminated constructions having a 48-inch width were slit industrially to form floor marking tapes having widths of 2-inches. From the tapes having a width of 2-inches, samples were cut into 2-inch×2-foot floor marking tapes for testing.

For each example, the thickness of the top layer (18 mil) and the adhesive layer (2 mil) is the same. Each layer has substantially uniform thickness from edge-to-edge. A summary of the structure of each Structure II example floor marking tape is provided below in Table 4.

TABLE 4

| | | Top | | Total |
|---|---|---|---|---|
| | Top | Layer | First | Tape |
| | Layer | Thickness | Adhesive | Thickness |
| Ex. | Polymer | (mil) | Layer | (mil) |
| V | RTP 700 ABR | 18 | AH 115* | 20 |
| W | RTP 700 ABR | 18 | MORSTIK 123 | 20 |

*LOCTITE DURO-TAK AH 115

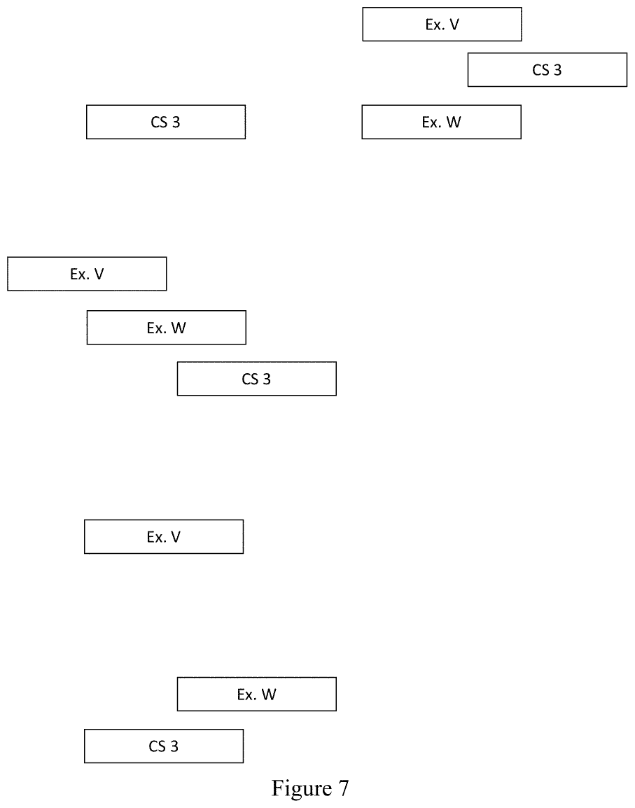

Round 3: The areas of lower relative traffic were identified following Round 1. Example 2-inch×2-foot floor marking tapes produced as described above were placed in the identified high traffic areas of the operations receiving dock on the factory floor in the configuration depicted in FIG. 7. Photographs were taken on a weekly basis to monitor deterioration. A video camera was used to monitor for special cause-event analysis. Results are evaluated by visual assessment for tape loss and the type of failure mode (i.e., whether the top layer failed and/or the adhesive failed).

### Structure V Examples

Examples having the Structure V disclosed above and depicted in FIG. 3 are formed using the materials of Tables 1 and 2.

The top layers are formed in a three-roll stack extrusion process using a Wiman extruder to produce rollform-extruded polymer film. The middle roller is chrome, which imparts a high gloss finish to the film.

The first adhesive is coated onto a differential release liner via slot die coating and is then exposed to heat and convective air movement to form a first adhesive layer (2 mil thick or 1 mil thick, as shown in Table 5). The first adhesive layer/release liner structure is then laminated with a top layer, such that the adhesive layer directly contacts the top layer. The layers were hand-laminated using a 4.5-pound roller. The differential release liner is then removed to form a top layer/first adhesive layer structure.

B-483A is provided. B-483A is a glossy yellow multi-layer film containing a pigment layer, a white polyester layer (thickness=2 mil) in contact with the pigment layer, a rubber-based PSA (thickness=2 mil) in contact with the white polyester layer, and a release liner in contact with the rubber-based PSA. B-483A has a total thickness of 4 mil (excluding the release liner), meaning that the pigment layer has a thickness of greater than 0 mil, but less than 0.0001 mil.

The top layer/first adhesive layer structure is then laminated to the B-483A, such that the first adhesive layer contacts the pigment layer of the B-483A. The layers were hand-laminated using a 4.5-pound roller. The hand-laminated constructions were then cut with a guillotine blade paper cutter into 2-inch×2-foot floor marking tapes for testing. The release liner (from the original B-483A structure) is removed before placement of the floor marking tape example onto a substrate.

For each of Ex. X, Ex. Y, Ex. Z, Ex. AA, Ex. AB, Ex. AC, Ex. AD, and Ex. AE, the pigment layer, intermediate layer (i.e., white polyester layer), second adhesive layer (i.e., rubber-based PSA), and release liner are obtained through the incorporation of the B-483A into the floor marking tape structure.

For each example, the thickness of the top layer (18 mil), pigment layer (negligible), intermediate layer (2 mil), and the second adhesive layer (2 mil) is the same. Each layer has substantially uniform thickness from edge-to-edge. A summary of the structure of each Structure V example floor marking tape is provided below in Table 5.

TABLE 5

| | | First Adhe- | | Total |
|---|---|---|---|---|
| | Top | sive Layer | First | Tape |
| | Layer | Thickness | Adhesive | Thickness |
| Ex. | Polymer | (mil) | Layer | (mil) |
| X | VERSIFY 3000 | 2 | AH 115* | 24 |
| Y | VERSIFY 3000 | 2 | MORSTIK 123 | 24 |
| Z | ECOZEN T110 Plus | 2 | AH 115* | 24 |
| AA | ECOZEN T110 Plus | 2 | MORSTIK 123 | 24 |
| AB | ECOZEN T110 Plus | 1 | 230A** | 23 |
| AC | SKYGREEN JN200 | 2 | AH 115* | 24 |
| AD | SKYGREEN JN200 | 2 | MORSTIK 123 | 24 |
| AE | SKYGREEN JN200 | 1 | 230A** | 23 |

*LOCTITE DURO-TAK AH 115
**LOCTITE DURO-TAK 230A

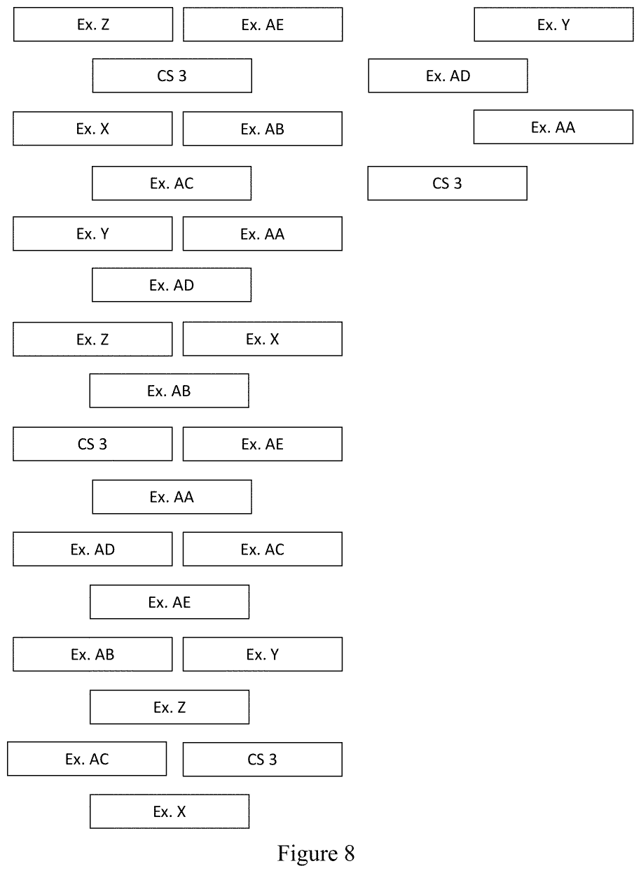

Round 4: The areas of lower relative traffic were identified following Round 1. Example 2-inch×2-foot floor marking tapes produced as described above were placed in the identified high traffic areas of the operations receiving dock on the factory floor in the configuration depicted in FIG. 8. Photographs were taken on a weekly basis to monitor deterioration. A video camera was used to monitor for special cause-event analysis. Results are evaluated by visual assessment for tape loss and the type of failure mode (i.e., whether the top layer failed and/or the adhesive failed).

### Results

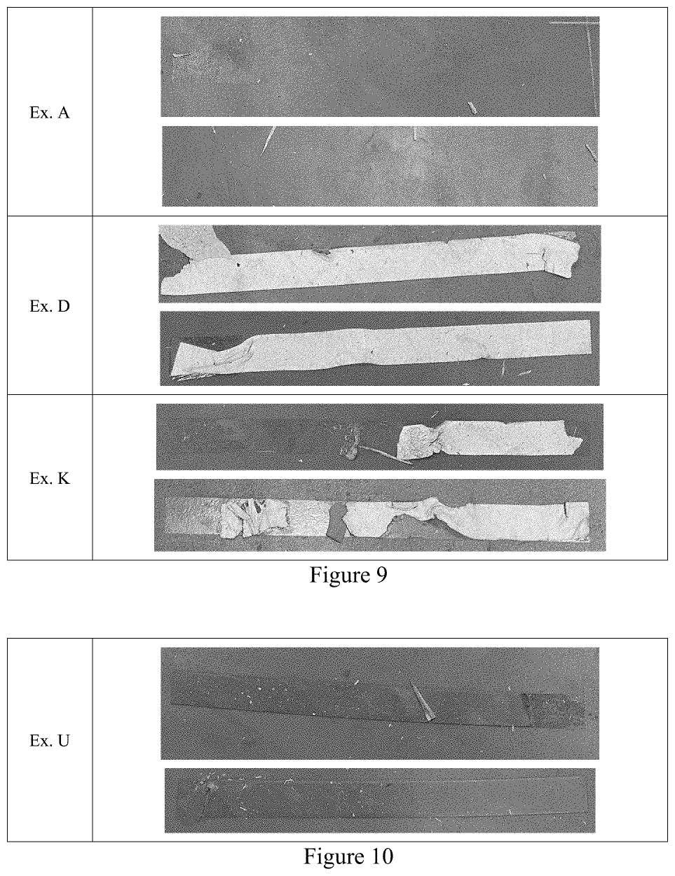

FIG. 9 depicts photographs of samples of each of Ex. A, Ex. D, and Ex. K taken seven weeks after each sample was placed on the floor during Round 1. Ex. A, Ex. D, and Ex. K each is formed with a top layer containing PVC #1, which has a flexural strength less than 2,100 psi (see Table 2). As shown in FIG. 9, regardless of the total thickness of the floor marking tape, warping is prevalent in Ex. D and Ex. K. Further, Ex. A has completely removed from the floor and significant portions of Ex. K have removed from the floor after seven weeks. Consequently, Ex. A, Ex. D, and Ex. K are not suitable for floor marking tape applications requiring durability.

FIG. 10 depicts photographs of samples of Ex. U taken seven weeks after each sample was placed on the floor during Round 1. Ex. U is formed with a top layer containing Red PVC, which has a flexural strength of less than 2,100 psi (see Table 2). As shown in FIG. 10, each of the Ex. U samples exhibited mass loss and/or warping after seven weeks, indicating that Ex. U is not suitable for floor marking tape applications requiring durability.

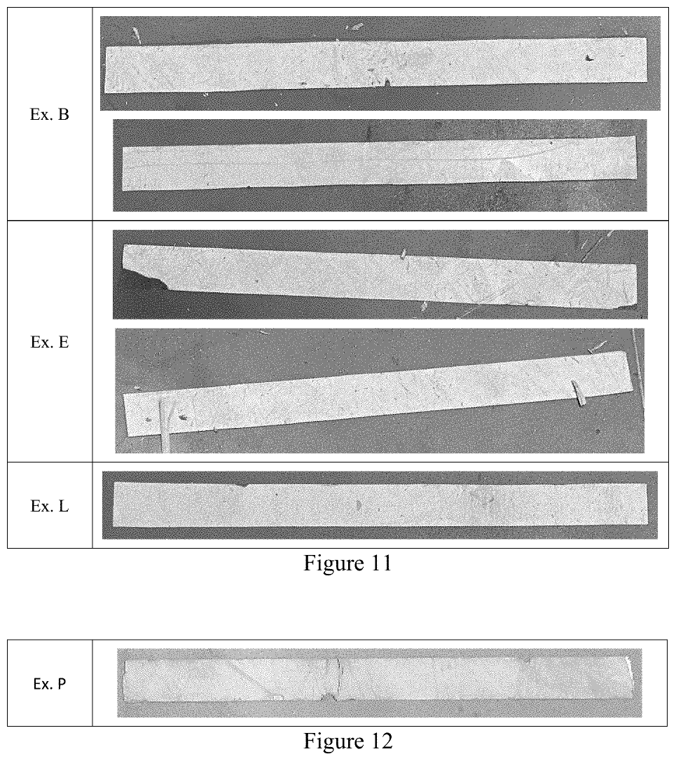

FIG. 11 depicts photographs of samples of each of Ex. B, Ex. E, and Ex. L taken seven weeks after each sample was placed on the floor during Round 1. Ex. B, Ex. E, and Ex. L each is formed with a top layer containing PVC #2, which has a flexural strength of greater than 2,100 psi (see Table 2). As shown in FIG. 11, regardless of the total thickness of the floor marking tape, the samples exhibit little-to-no warping or mass loss, indicating that each of Ex. B, Ex. E, and Ex. L is suitable for floor marking tape applications requiring durability. However, Ex. B has a total thickness of 47 mil, meaning that Ex. B may be a barrier to objects moving over the floor marking tape (such as wheels of a handcart). In contrast, Ex. E and Ex. L have thickness of 32 mil and 22 mil, respectively, which would not pose a barrier to objects moving over the floor marking tape.

FIG. 12 depicts a photograph of a sample of Ex. P taken seven weeks after the sample was placed on the floor during Round 2. Ex. P is formed with a top layer containing RTP 200 A ABR, which has a flexural strength of greater than 2,100 psi (see Table 2). As shown in FIG. 12, the sample exhibits little-to-no warping or mass loss, indicating that Ex. P is suitable for floor marking tape applications requiring durability.

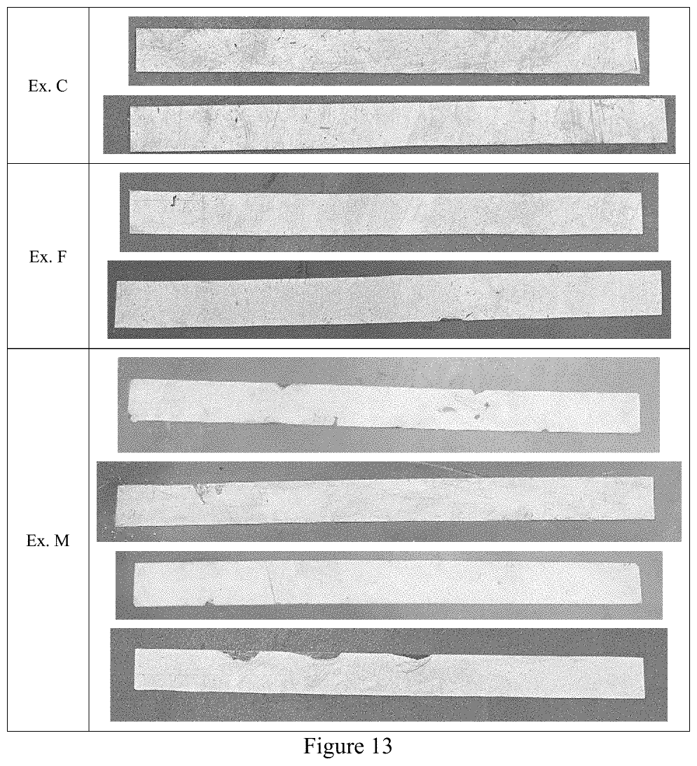

FIG. 13 depicts photographs of samples of each of Ex. C, Ex. F, and Ex. M taken seven weeks after each sample was placed on the floor during Round 1 and Round 2 (for Ex. M). Ex. C, Ex. F, and Ex. M each is formed with a top layer containing PVC #3, which has a flexural strength of greater than 2,100 psi (see Table 2). As shown in FIG. 13, regardless of the total thickness of the floor marking tape, the samples exhibit little-to-no warping or mass loss, indicating that each of Ex. C, Ex. F, and Ex. M is suitable for floor marking tape applications requiring durability. However, Ex. C has a total thickness of 47 mil, meaning that Ex. C may be a barrier to objects moving over the floor marking tape (such as wheels of a handcart). In contrast, Ex. F and Ex. M have thickness of 32 mil and 22 mil, respectively, which would not pose a barrier to objects moving over the floor marking tape.

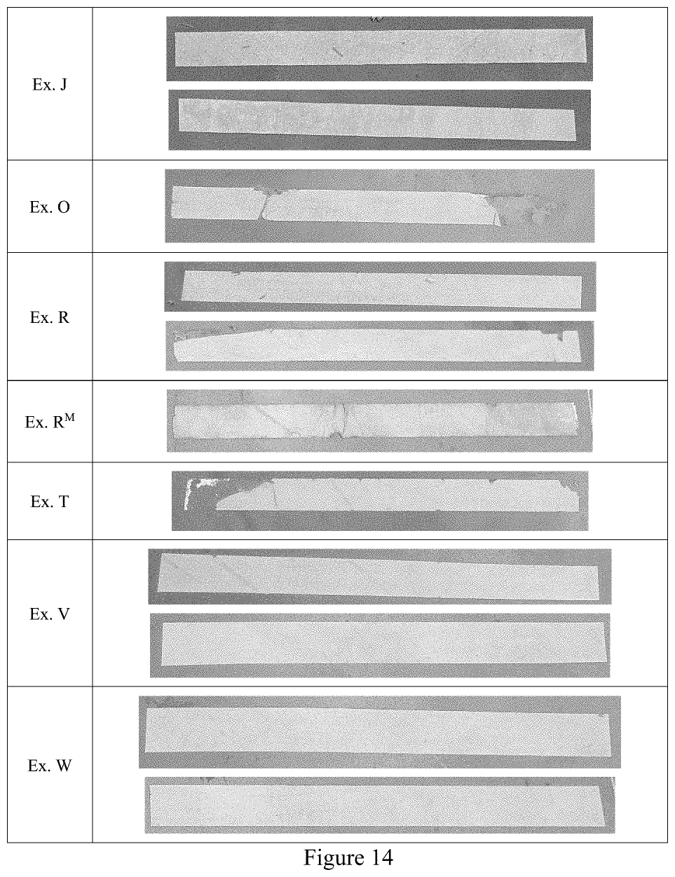

FIG. 14 depicts photographs of samples of each of Ex. J, Ex. O, Ex. R, Ex. R^{M}, Ex. T, Ex. V, and Ex. W taken seven weeks after each sample was placed on the floor during Rounds 1, 2, and 3 (as shown in FIGS. 5-7). Ex. J, Ex. O, Ex. R, Ex. RM, Ex. T, Ex. V, and Ex. W each is formed with a top layer containing RTP 700 ABR, which has a flexural strength of greater than 2,100 psi (see Table 2). As shown in FIG. 14, the samples exhibit little-to-no warping or mass loss, indicating that each of Ex. J, Ex. O, Ex. R, Ex. R^{M}, Ex. T, Ex. V, and Ex. W is suitable for floor marking tape applications requiring durability.

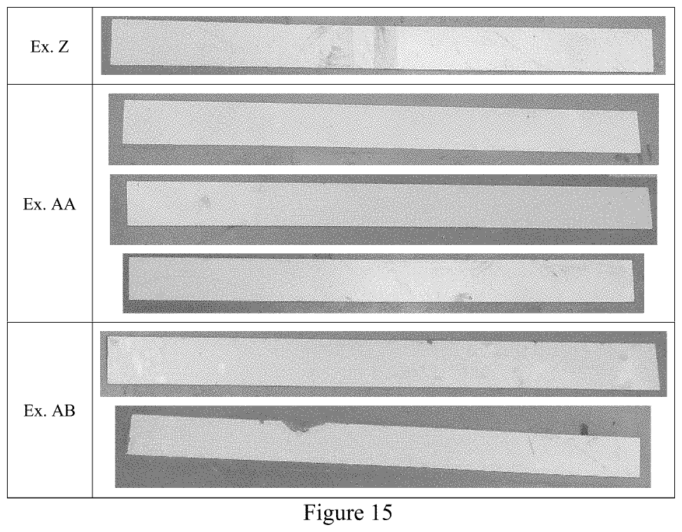

FIG. 15 depicts photographs of samples of each of Ex. Z, Ex. AA, and Ex. AB taken seven weeks after each sample was placed on the floor during Round 4. Ex. Z, Ex. AA, and Ex. AB each is formed with a top layer containing Ecozen T110 Plus, which has a flexural strength of greater than 2,100 psi (see Table 2). As shown in FIG. 15, the samples exhibit little-to-no warping or mass loss, indicating that each of Ex. Z, Ex. AA, and Ex. AB is suitable for floor marking tape applications requiring durability.

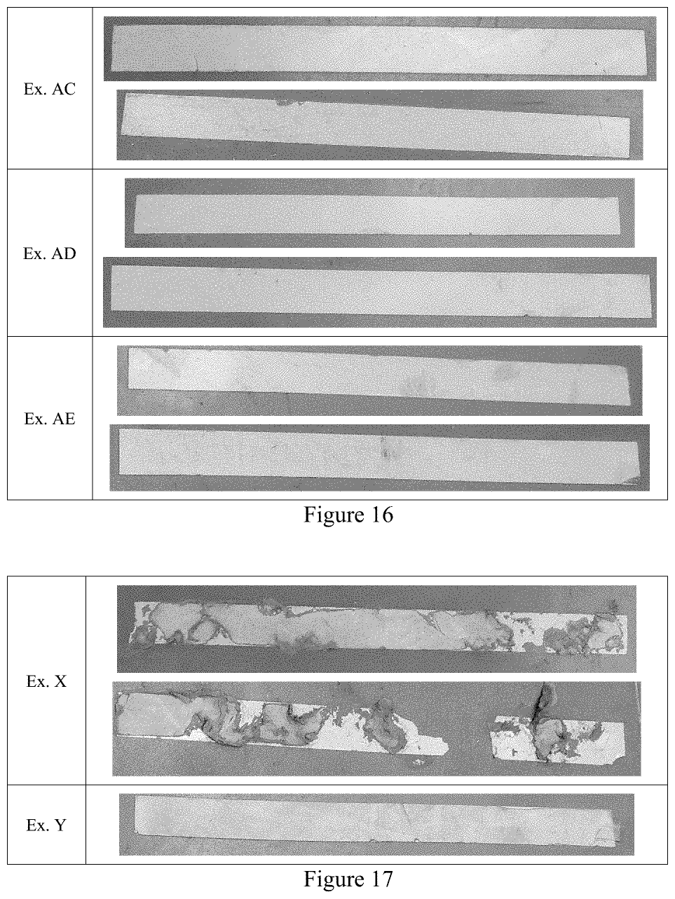

FIG. 16 depicts photographs of samples of each of Ex. AC, Ex. AD, and Ex. AE taken seven weeks after each sample was placed on the floor during Round 4. Ex. AC, Ex. AD, and Ex. AE each is formed with a top layer containing Skygreen JN200, which has a flexural strength of greater than 2,100 psi (see Table 2). As shown in FIG. 16, the samples exhibit little-to-no warping or mass loss, indicating that each of Ex. AC, Ex. AD, and Ex. AE is suitable for floor marking tape applications requiring durability.

FIG. 17 depicts photographs of samples of each of Ex. X and Ex. Y taken seven weeks after each sample was placed on the floor during Round 4. Ex. X and Ex. Y each is formed with a top layer containing Versify 3000, which has a flexural strength of less than 2,100 psi (see Table 2). As shown in FIG. 17, the samples of Ex. X exhibit significant mass loss and/or delamination, indicating that Ex. X is not suitable for floor marking tape applications requiring durability. While Ex. Y did not exhibit mass loss, the sample began to delaminate in the bottom left corner, suggesting that Ex. Y is not suitable for floor marking tape applications requiring durability.

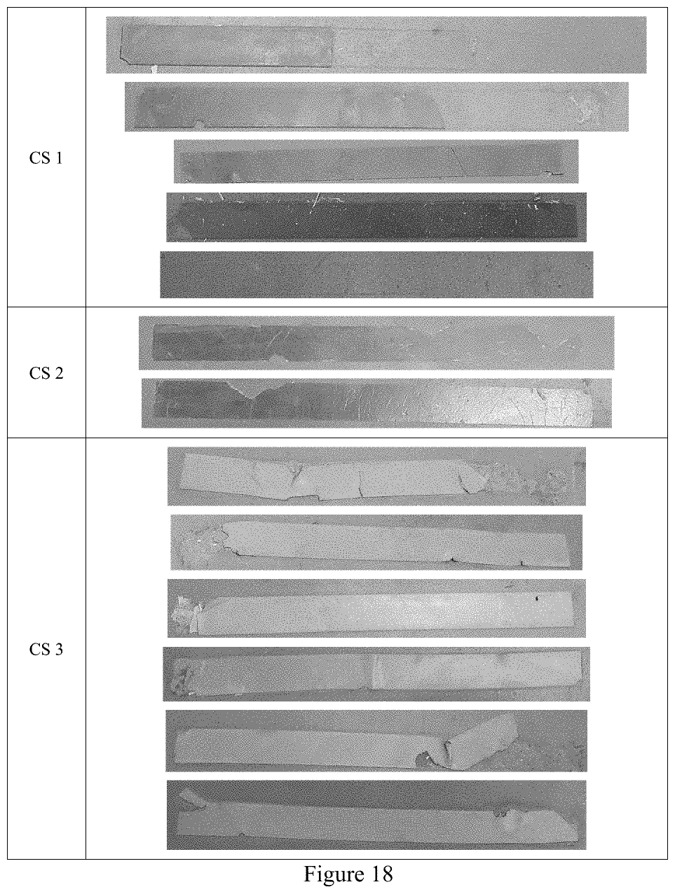

FIG. 18 depicts photographs of samples of each of CS 1, CS 2, and CS 3 taken seven weeks after each sample was placed on the floor during Rounds 1-4. CS 1, CS 2, and CS 3. Most of the samples of CS 1 and CS 3 exhibit significant warping and/or mass loss, indicating that CS 1 and CS 3 are not suitable for floor marking tape applications requiring durability. Moreover, CS 1 and CS 3 each has a total thickness of 46.1 mil, meaning that CS 1 and CS 3 may be a barrier to objects moving over the floor marking tape (such as wheels of a handcart).

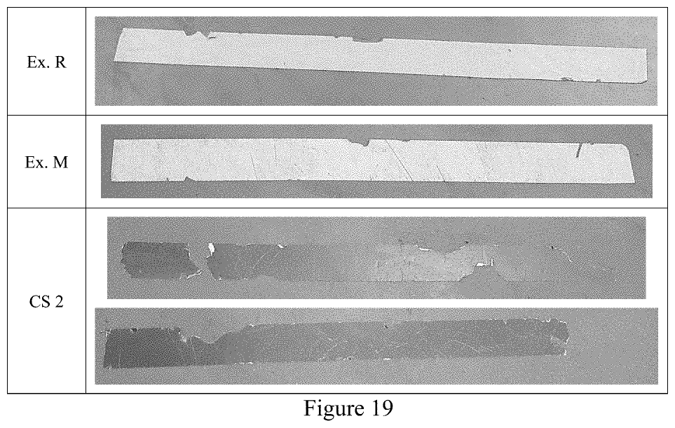

As shown in FIG. 18, after seven weeks, CS 2 has begun to exhibit mass loss. After twenty-three weeks, that mass loss is even more significant. FIG. 19 depicts photographs of samples of each of CS 2, Ex. R, and Ex. M taken twenty-three weeks after each sample was placed on the floor during Round 2. As shown, CS 2 exhibits significant mass loss, indicating that CS 2 is not suitable for floor marking tape applications requiring durability over extended periods of time (here, 23 weeks). In contrast, Ex. R and Ex M (which are each formed with a top layer having a flexural strength greater than 2,100 psi) each exhibits little mass loss after twenty-three weeks, indicating that Ex. R and Ex. M are suitable for floor marking tape applications requiring durability over extended periods of time (here, 23 weeks).

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A floor marking tape comprising:
(A) a top layer comprising a polymer having a flexural strength of greater than 2,100 psi; and
(B) an adhesive layer comprising a pressure sensitive adhesive in contact with the top layer;
the floor marking tape having a total thickness of less than 40 mil.

2. The floor marking tape of claim 1, wherein the top layer has a thickness from 15 mil to 18 mil.

3. The floor marking tape of claim 1, wherein the polymer is selected from the group consisting of polyolefins, polyamides, vinyl polymers, polycarbonates, polyesters, and combinations thereof.

4. The floor marking tape of claim 1, wherein the polymer is selected from the group consisting of HDPE, polypropylene, polybutene, nylon, polycarbonate, PVC, PVDF, PCTG, PETG, and combinations thereof.

5. The floor marking tape of claim 1, wherein the polymer has a flexural strength of from 2,100 psi to 15,000 psi.

6. The floor marking tape of claim 1, wherein the polymer has at least one of the following properties:
(i) a tensile strength of from 3,500 psi to 9,000 psi; and/or
(ii) a Shore D of from 65 to 90; and/or
(iii) a Rockwell hardness (R-scale) of from 50 to 130; and/or
(iv) a storage modulus (G′) of from 1,000 MPa to 2,000 MPa.

7. The floor marking tape of claim 1, wherein the floor marking tape has two opposing edge surfaces and the adhesive layer has a substantially uniform thickness extending from one edge surface to the opposing edge surface.

8. The floor marking tape of claim 1 further comprising a pigment layer comprising a pigment, wherein the pigment layer is a non-surface layer that contacts the top layer.

9. The floor marking tape of claim 1, wherein the floor marking tape has a total thickness of from 15 mil to less than 40 mil.

10. The floor marking tape of claim 1, wherein the top layer is translucent.

11. A floor marking tape comprising:
(A) a top layer comprising a first polymer having a flexural strength of greater than 2,100 psi;
(B) a first adhesive layer comprising a first pressure sensitive adhesive in contact with the top layer;
(C) an intermediate layer comprising a second polymer in contact with the first adhesive layer; and
(D) a second adhesive layer comprising a second pressure sensitive adhesive in contact with the intermediate layer;
the floor marking tape having a total thickness of less than 40 mil.

12. The floor marking tape of claim 11, wherein the top layer has a thickness from 15 mil to 18 mil.

13. The floor marking tape of claim 11, wherein the first polymer is selected from the group consisting of polyolefins, polyamides, vinyl polymers, polycarbonates, polyesters, and combinations thereof.

14. The floor marking tape of claim 11, wherein the first polymer is selected from the group consisting of HDPE, polypropylene, polybutene, nylon, polycarbonate, PVC, PVDF, PCTG, PETG, and combinations thereof.

15. The floor marking tape of claim 11, wherein the first polymer has a flexural strength of from 2,100 psi to 15,000 psi.

16. The floor marking tape of claim 11, wherein the first polymer has at least one of the following properties:
(i) a tensile strength of from 3,500 psi to 9,000 psi; and/or
(ii) a Shore D of from 65 to 90; and/or
(iii) a Rockwell hardness (R-scale) of from 50 to 130; and/or
(iv) a storage modulus (G′) of from 1,000 MPa to 2,000 MPa.

17. The floor marking tape of claim 11, wherein the floor marking tape has two opposing edge surfaces and each of the first adhesive layer and the second adhesive layer has a substantially uniform thickness extending from one edge surface to the opposing edge surface.

18. The floor marking tape of claim 11 further comprising a pigment layer comprising a pigment, wherein the pigment layer contacts the first adhesive layer and the intermediate layer.

19. The floor marking tape of claim 11, wherein the floor marking tape has a total thickness of from 15 mil to less than 40 mil.

20. The floor marking tape of claim 11, wherein the top layer is translucent.
